(19) United States
(12) Patent Application Publication
(10) Pub. No.: US 2014/0061551 A1
(43) Pub. Date: Mar. 6, 2014

(54) METHOD OF MANUFACTURING CONDUCTIVE MAYENITE COMPOUND

(71) Applicant: ASAHI GLASS COMPANY, LIMITED, Chiyoda-ku (JP)

(72) Inventors: Kazuhiro Ito, Tokyo (JP); Toshinari Watanabe, Tokyo (JP); Satoru Watanabe, Tokyo (JP); Naomichi Miyakawa, Tokyo (JP)

(73) Assignee: ASAHI GLASS COMPANY, LIMITED, Chiyoda-ku (JP)

(21) Appl. No.: 14/079,078

(22) Filed: Nov. 13, 2013

Related U.S. Application Data
(63) Continuation of application No. PCT/JP2012/061687, filed on May 7, 2012.

(30) Foreign Application Priority Data
May 13, 2011 (JP) 2011-107902
Oct. 7, 2011 (JP) 2011-223029

(51) Int. Cl. C01F 7/16

(52) U.S. Cl. CPC C01F 7/164
USPC 252/518.1; 423/600

(57) ABSTRACT

A method of manufacturing an electrical conductive mayenite compound, including, (1) a step of preparing a calcinated powder including calcium oxide and aluminum oxide at a ratio of 13:6 to 11:8 (based on molar ratio as converted to CaO:Al₂O₃), and (2) a step of placing a body to be processed including the calcinated powder prepared in the step (1) in the presence of carbon monoxide gas and aluminum vapor supplied from the aluminum source without contacting the aluminum source, and holding the body to be processed at a temperature range of 1220° C. to 1350° C. under reducing atmosphere.

### CROSS-REFERENCE TO RELATED APPLICATION

This application is a continuation application filed under 35 U.S.C. 111(a) claiming the benefit under 35 U.S.C. 120 and 365(c) of PCT International Application No. PCT/JP2012/061687 filed on May 7, 2012, which is based upon and claims the benefit of priority of Japanese Priority Application No. 2011-107902 filed on May 13, 2011, and Japanese Priority Application No. 2011-223029 filed on Oct. 7, 2011, the entire contents of which are hereby incorporated by reference.

### BACKGROUND OF THE INVENTION

1. Field of the Invention

The present invention relates to a method of manufacturing an electrical conductive mayenite compound.

2. Description of the Related Art

A mayenite compound has a typical composition expressed as 12CaO.7Al₂O₃, and has a characteristic crystalline structure including three-dimensionally connected cages, each having a diameter about 0.4 nm. A skeletal structure structuring the cages is positively charged, and forms twelve cages per unit lattice. ⅙ of the cages are occupied with oxygen ions in their inside, respectively, in order to satisfy an electrical neutrality condition of the crystal. However, the oxygen ions inside the cages have a chemical characteristic different from the oxygen ions composing the skeletal structure. Thus, the oxygen ions inside the cages are specifically referred to as “free oxygen ions”. The mayenite compound is also expressed as [Ca₂₄Al₂₈O₆₄]⁴⁺.2O²⁻ (Non-Patent Document 1).

When a part of or all of the free oxygen ions inside the cages of the mayenite compound are substituted for by electrons, the mayenite compound is provided with an electrical conductivity. This is because, the electrons included in the cages of the mayenite compound can freely move in the crystal without being tied by the respective cage (Patent Document 1). Such a mayenite compound with the electrical conductivity is referred to, in particular, as an “electrical conductive mayenite compound”.

Such an electrical conductive mayenite compound may be manufactured by, for example, a method of manufacturing by putting a mayenite compound powder in a carbon container with a cover and performing a heat treatment at 1300° C. under nitrogen gas atmosphere (Patent Document 2). Hereinafter, this method is referred to as a “conventional method 1”.

Further, such an electrical conductive mayenite compound may be manufactured by a method of manufacturing by putting a mayenite compound in an alumina container with a cover with aluminum and performing a heat treatment at 1300° C. in vacuum (Patent Document 2). Hereinafter, this method is referred to as a “conventional method 2”.

### PATENT DOCUMENTS

[Patent Document 1] WO 2005/000741
[Patent Document 2] WO 2006/129674

### NON-PATENT DOCUMENT

[Non-Patent Document 1] F. M. Lea, C. H. Desch, The Chemistry of Cement and Concrete, 2nd ed., p. 52, Edward Arnold&Co., London, 1956

The electrical conductive mayenite compound is expected to be applied as an electrode material for a fluorescent lamp, for example. However, according to the above described conventional method 1, there is a problem in that it is difficult to obtain an electrical conductive mayenite compound with a sufficiently high electron density (in other words, whose electrical conductivity is sufficiently high enough). The electron density of the electrical conductive mayenite compound obtained by the conventional method 1 is less than 3×10²⁰ cm⁻³.

If such an electrical conductive mayenite compound with a low electron density is used as an electrode material for a fluorescent lamp or the like, for example, Joule heat is generated due to the low electrical conductivity to cause a high temperature of the electrical conductive mayenite compound. In general, the fluorescent lamp lights within a few seconds, Joule heat is generated every time the fluorescent lamp lights and a thermal stress is generated in the electrical conductive mayenite compound. When the thermal stress is accumulated, there is a possibility that a cracking or a breaking occurs in the electrical conductive mayenite compound to be damaged. With such background, it is required to further increase electron density of the electrical conductive mayenite compound in order to increase the electrical conductivity of the electrical conductive mayenite compound. Here, it is known that the electron density of the electrical conductive mayenite compound is at most 2.3×10²¹ cm⁻³ when almost all of the free oxygen ions are substituted for by electrons.

On the other hand, according to the above described conventional method 2, an electrical conductive mayenite compound with a high electron density more than 1×10²¹ cm⁻³ can be obtained. However, it is necessary to heat the mayenite compound while contacting with aluminum. The present inventors have found the following problem for this case.

As the melting point of aluminum is 660° C., if the mayenite compound and aluminum are heated at a temperature higher or equal to the melting point, liquid aluminum is formed at a surface of the mayenite compound. When the temperature is lowered to room temperature under this state, aluminum solid body is adhered to the surface of the electrical conductive mayenite compound. Such an adhered body strongly bonds to the electrical conductive mayenite compound and it is not easy to peel or remove the adhered body. Thus, if such a phenomenon occurs, a process step is required, which lacks productivity.

On the other hand, even when the mayenite compound is heated under aluminum vapor atmosphere without contacting the aluminum solid body, the electrical conductive mayenite compound with a high electron density cannot be obtained within realistic time.

When the mayenite compound is heated under aluminum vapor atmosphere, an oxide insulating layer including calcium aluminate (CaO.Al₂O₃, for example) is formed at a surface of the mayenite compound. Such an insulating layer blocks diffusion of the aluminum vapor into the mayenite compound. Thus, if the mayenite compound is heated under aluminum vapor atmosphere without contacting the aluminum solid body, reduction reaction of the mayenite compound is extremely lowered and extremely long time heat treatment is necessary to increase the electron density.

### SUMMARY OF THE INVENTION

The present invention is made in light of the above problems, and provides a method of effectively manufacturing an electrical conductive mayenite compound with a high electron density.

According to the first embodiment, there is provided a method of manufacturing an electrical conductive mayenite compound, including

(1) a step of preparing a calcinated powder including calcium oxide and aluminum oxide at a ratio of 13:6 to 11:8 (molar ratio), and
(2) a step of placing a body to be processed including the calcinated powder prepared in the step (1) in the presence of carbon monoxide gas and aluminum vapor supplied from an aluminum source without contacting the aluminum source, and holding the body to be processed at a temperature range of 1220° C. to 1350° C. under reducing atmosphere.

Here, in the manufacturing method of the first embodiment, the calcinated powder may be manufactured by performing a heat treatment on a mixture of

a raw material A including at least one selected from a group consisting of calcium oxide, calcium carbonate and calcium hydroxide, and

a raw material B including one selected from a group consisting of aluminum oxide and aluminum hydroxide.

Further, in the manufacturing method of the first embodiment, the heat treatment may be performed at 500° C. to 1200° C.

Further, in the manufacturing method of the first embodiment, the body to be processed including the calcinated powder may be a compact body including the calcinated powder.

Further, in the manufacturing method of the first embodiment, the step (2) may be performed at a state where the body to be processed and the aluminum source are put in a container containing carbon.

Further, in the manufacturing method of the first embodiment, the step (2) may be performed under a reduced pressure environment less than or equal to 100 Pa, or under inert-gas, except nitrogen, atmosphere.

Further, in the manufacturing method of the first embodiment, in the step (1), the calcinated powder including calcium oxide and aluminum oxide at a ratio of 12.6:6.4 to 11.7:7.3 (molar ratio) may be prepared.

In the second embodiment, there is provided a method of manufacturing a high electrical conductive mayenite compound, including

(1) a step of preparing a mayenite compound powder; and
(2) a step of placing a body to be processed including the compound powder prepared in the step (1) in the presence of carbon monoxide gas and aluminum source supplied from an aluminum vapor without contacting the aluminum source, and holding the body to be processed at a temperature range of 1230° C. to 1415° C. under reducing atmosphere.

Here, according to the manufacturing method of the second embodiment, the step (2) may be performed under a state where the body to be processed and the aluminum source are put in a container containing carbon.

Further, in the manufacturing method of the second embodiment, the high electrical conductive mayenite compound having an aluminum carbide layer at a surface may be obtained by the step (2).

Further, according to the manufacturing method of the second embodiment, the body to be processed including the mayenite compound powder may be a compact body including the mayenite compound powder.

Further, according to the manufacturing method of the second embodiment, the step (2) may be performed under a reduced pressure environment less than or equal to 100 Pa, or under inert-gas, except nitrogen, atmosphere.

Further, according to the manufacturing method of the second embodiment, the high electrical conductive mayenite compound whose electron density is more than or equal to 3×10²⁰ cm⁻³ may be obtained.

Note that also arbitrary combinations of the above-described elements, and any changes of expressions in the present invention, made among methods, devices and so forth, are valid as embodiments of the present invention.

According to the present invention, a method of effectively manufacturing an electrical conductive mayenite compound with a high electron density is provided.

### BRIEF DESCRIPTION OF THE DRAWINGS

Other objects, features and advantages of the present invention will become more apparent from the following detailed description when read in conjunction with the accompanying drawings.

FIG. 1 is a flowchart schematically illustrating an example of a method of manufacturing an electrical conductive mayenite compound according to a first embodiment;

FIG. 2 is a view schematically illustrating an example of a structure of an apparatus that is used when performing a high temperature treatment on a body to be processed;

FIG. 3 is a view schematically illustrating a structure of an apparatus that is used when performing a high temperature treatment on a compact body B1 of an example 1; and

FIG. 4 is a flowchart schematically illustrating an example of a method of manufacturing a high electrical conductive mayenite compound according to a second embodiment.

### DETAILED DESCRIPTION OF THE PREFERRED EMBODIMENTS

### First Embodiment

In the first embodiment, there is provided a method of manufacturing an electrical conductive mayenite compound, including

(1) a step of preparing a calcinated powder including calcium oxide and aluminum oxide at a ratio of 14:5 to 10:9 (molar ratio); and
(2) a step of placing a body to be processed including the calcinated powder prepared in the step (1) in the presence of carbon monoxide gas and aluminum vapor supplied from an aluminum source without contacting the aluminum source, and holding the body to be processed at a temperature range of 1220° C. to 1350° C. under reducing atmosphere.

In the application, a “mayenite compound” is a generic name of 12CaO.7Al₂O₃ (hereinafter, referred to as “C12A7”) and a compound (an isomorphous compound) having a similar crystalline structure as C12A7, having a cage structure.

Further, in the application, an “electrical conductive mayenite compound” expresses a mayenite compound in which a part of or all of the “free oxygen ions” included in the cages are substituted for by electrons and having an electron density of more than or equal to 1.0×10¹⁸ cm⁻³. The electron density is 2.3×10²¹ cm⁻³ when all of the free oxygen ions are substituted for by electrons.

Thus, the “mayenite compound” includes the “electrical conductive mayenite compound” and a “non-electrical conductive mayenite compound”.

According to the first embodiment, the electron density of the manufactured “electrical conductive mayenite compound” is, preferably, more than or equal to 3.0×10²⁰ cm⁻³ and the “electrical conductive mayenite compound” having a significantly high electron density compared with a conventional method using a carbon container with a cover can be obtained.

Hereinafter, in the application, the electrical conductive mayenite compound having an electron density more than or equal to 3.0×10²⁰ cm⁻³ is specifically referred to as a “high electrical conductive mayenite compound”.

Here, generally, the electron density of the electrical conductive mayenite compound is measured by one of two methods based on the electron density of the mayenite compound. When the electron density is 1.0×10¹⁸ cm⁻³ to less than 3.0×10²⁰ cm⁻³, diffuse reflection of the electrical conductive mayenite compound powder is measured, the diffuse reflection is performed with Kubelka-Munk transformation to obtain absorption spectra, and the electron density is calculated from the absorbance (Kubelka-Munk transformation value) at 2.8 eV (wavelength 443 nm) of the obtained absorption spectra. This method is based on a fact that the electron density and the Kubelka-Munk transformation value have a linear relationship. Hereinafter, a method of creating a calibration curve is explained.

First, four samples having different electron densities are prepared and electron densities of the four samples are obtained from signal strengths of electron spin resonance (ESR). The electron density capable of being measured by ESR is about 1.0×10¹⁴ cm⁻³ to 1.0×10¹⁹ cm⁻³. Logarithms of the Kubelka-Munk values and electron densities obtained by ESR are plotted to obtain a linear relationship and the obtained linear line was used as the calibration curve. It means that in this method, when the electron density is 1.0×10¹⁹ cm⁻³ to 3.0×10²⁰ cm⁻³, the calibration curve is obtained by extrapolation.

When the electron density is 3.0×10²⁰ cm⁻³ to 2.3×10²¹ cm⁻³, diffuse reflection of the electrical conductive mayenite compound powder is measured, the diffuse reflection is processed with Kubelka-Munk transformation to obtain absorption spectra, and the electron density is obtained by a conversion using a wavelength (energy) of a peak of the absorption spectra. The following relationship was used.

n=(−(Eₛₚ−2.83)/0.199)^{0.782}

Here, “n” indicates the electron density (cm⁻³), and “Eₛₚ” indicates energy (eV) of the peak of the absorption spectra obtained by Kubelka-Munk transformation.

Further, in the application, for the electrical conductive mayenite compound, a part of at least one kind of atom selected from calcium (Ca), aluminum (Al) and oxygen (O) may be substituted for by another atom or an atom group as long as the electrical conductive mayenite compound has a C12A7 crystalline structure composed of calcium (Ca), aluminum (Al) and oxygen (O). For example, a part of calcium (Ca) may be substituted for by one or more atom(s) selected from a group consisting of magnesium (Mg), strontium (Sr), barium (Ba), lithium (Li), sodium (Na), chrome (Cr), manganese (Mn), cerium (Ce), cobalt (Co), nickel (Ni) and copper (Cu). Further, a part of aluminum (Al) may be substituted for by one or more atom(s) selected from a group consisting of silicon (Si), germanium (Ge), boron (B), gallium (Ga), titanium (Ti), manganese (Mn), iron (Fe), cerium (Ce), praseodymium (Pr), scandium (Sc), lanthanum (La), yttrium (Y), europium (Eu), ytterbium (Yb), cobalt (Co), nickel (Ni) and terbium (Tb). Further, the oxygen of the skeletal structure of the cages may be substituted for by nitrogen (N) or the like.

In the manufacturing method of the first embodiment, different from the above described conventional method 2, the body to be processed is placed in the presence of the carbon monoxide gas and the aluminum vapor without contacting the aluminum source. Thus, in the manufacturing method of the first embodiment, the aluminum adhered body is not adhered to the surface of the obtained electrical conductive mayenite compound. Therefore, it is unnecessary to peel or remove the adhered body from the electrical conductive mayenite compound after the process.

Further, in the manufacturing method of the first embodiment, the calcinated powder having the above described composition is used as the body to be processed and the calcinated powder is exposed to carbon monoxide gas and aluminum vapor. Thus, in the first embodiment, when the calcinated powder is heated to a temperature more than or equal to a predetermined temperature, calcium oxide and aluminum oxide in the calcinated powder react with each other to generate the non-electrical conductive mayenite compound. The generated non-electrical conductive mayenite compound is reduced as the free oxygen in the cages is rapidly substituted for by electrons (actually, at the same time as generation of the non-electrical conductive mayenite compound). With this, the high electrical conductive mayenite compound is generated. Thereafter, similar to a sintering process of ordinal ceramics particles, generated high electrical conductive mayenite compound powder is sintered and a sintered body of the high electrical conductive mayenite compound is formed.

As such, according to the first embodiment, the sintered body of the electrical conductive mayenite compound can be generated “directly” from the raw material including the calcinated powder. Thus, different from the conventional method in which the mayenite compound is heated under aluminum vapor atmosphere without carbon monoxide gas and without contacting the aluminum solid body, in the first embodiment, the problem in that an insulating layer is formed at a surface of the mayenite compound while processing and diffusion of the reduction species into inside is limited, can be prevented.

As such, according to the first embodiment, the electrical conductive mayenite compound with a sufficient electron density can be obtained within relatively short time.

### (Method of Manufacturing Electrical Conductive Mayenite Compound of First Embodiment)

Hereinafter, the manufacturing method of the first embodiment is explained in detail with reference to drawings.

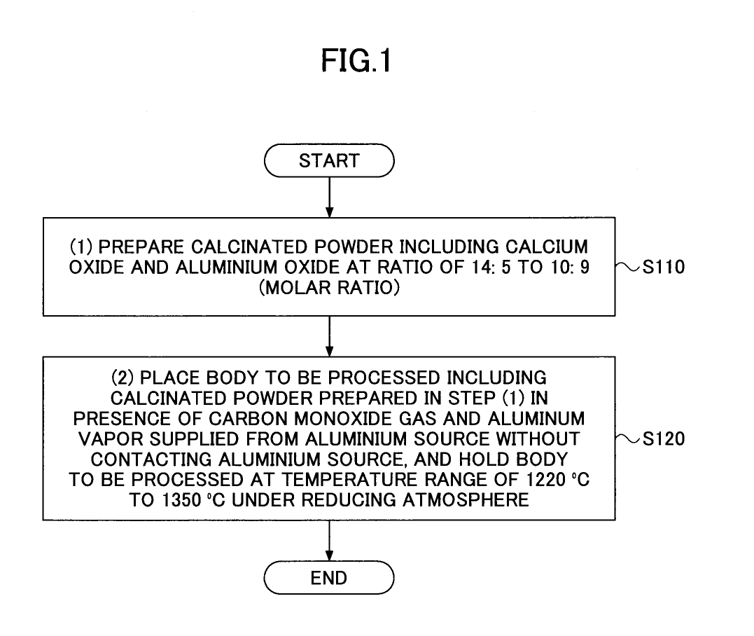

FIG. 1 illustrates a method of manufacturing the electrical conductive mayenite compound of the first embodiment.

As illustrated in FIG. 1, the manufacturing method of the first embodiment includes,

(1) a step of preparing a calcinated powder including calcium oxide and aluminum oxide at a ratio of 14:5 to 10:9 (molar ratio) (step S110), and
(2) a step of placing a body to be processed including the calcinated powder prepared in the step (1) in the presence of carbon monoxide gas and aluminum vapor supplied from an aluminum source without contacting the aluminum source, and holding the body to be processed at a temperature range of 1220° C. to 1350° C. under reducing atmosphere (step S120). Hereinafter, each of the steps is explained.

### (Step S110: Preparing Step of Calcinated Powder)

First, the calcinated powder for the body to be processed is prepared.

In the application, the “calcinated powder” means a mixed powder including calcium oxide and aluminum oxide prepared by a heat treatment. The “calcinated powder” is prepared such that the ratio of calcium (Ca) and aluminum (Al) becomes 14:5 to 10:9 based on molar ratio as converted to CaO:Al₂O₃.

In particular, the ratio of calcium (Ca) and aluminum (Al) is, preferably, 13:6 to 11:8, more preferably, 12.6:6.4 to 11.7:7.3, and furthermore preferably, 12.3:6.7 to 11.8:7.2, based on molar ratio as converted to CaO: Al₂O₃. Ideally, the molar ratio of calcium oxide and aluminum oxide is about 12:7.

The calcinated powder may be prepared as follows.

First, a mixed powder is prepared. The mixed powder includes at least raw materials that become a calcium oxide source and an aluminum oxide source.

For example, it is preferable that the mixed powder includes calcium aluminate, or, at least two compounds selected from a group consisting of a calcium compound, an aluminum compound and calcium aluminate.

The raw material powder may be, for example, a mixed powder including the calcium compound and the aluminum compound. The raw material powder may be, for example, a mixed powder including the calcium compound and calcium aluminate. The raw material powder may be, for example, a mixed powder including the aluminum compound and calcium aluminate. Further, the raw material powder may be, for example, a mixed powder including the calcium compound, the aluminum compound and calcium aluminate. Further, the raw material powder may be, for example, a mixed powder including only calcium aluminate.

Hereinafter, step S110 is explained while assuming that the mixed powder includes at least a raw material “A” that becomes the calcium oxide source and a raw material “B” that becomes the aluminum oxide source, as a representative.

For the raw material “A”, calcium carbonate, calcium oxide, calcium hydroxide, calcium hydrogencarbonate, calcium sulfate, calcium metaphosphate, calcium oxalate, calcium acetate, calcium nitrate, calcium halide or the like may be used. Among these, calcium carbonate, calcium oxide, and calcium hydroxide are preferably used.

For the raw material “B”, aluminum hydroxide, aluminum oxide, aluminum sulfate, aluminum nitrate, aluminum halide or the like may be used. Among these, aluminum hydroxide and aluminum oxide are preferably used.

Here, the calcinated powder may include a material other than the raw material “A” and the raw material “B”.

Next, the mixed powder including the raw material “A” and the raw material “B” is processed with heat treatment. With this, the calcinated powder including calcium oxide and aluminum oxide is obtained. As described above, the ratio, the molar ratio, of the calcium oxide and aluminum oxide in the calcinated powder is within a range of 12.6:6.4 to 11.7:7.3.

Further, the temperature of the heat treatment is within a range of about 500° C. to 1200° C.

Here, accurately, the temperature of the heat treatment varies in accordance with the raw material “A” and raw material “B” used. For example, when calcium oxide is used as the raw material “A” and aluminum oxide is used as the raw material “B”, the temperature of the heat treatment is within a range of 500° C. to 1200° C., for example. Further, when calcium carbonate is selected as the raw material “A”, as calcium carbonate decomposes into calcium oxide and carbon dioxide at about 900° C., it is necessary to set the temperature of the heat treatment for the mixed powder to be at least more than or equal to 900° C. Similarly, when calcium hydroxide is selected as the raw material “A”, calcium hydroxide decomposes into calcium oxide and water at a temperature about 450° C. to 500° C. Thus, it is necessary to set the temperature of the heat treatment for the mixed powder to be at least more than or equal to about 500° C. It can be considered similarly for other compounds as well.

The heat treatment may be performed in air.

The calcinated powder obtained after the heat treatment has, generally, a blocklike structure in which a part or all is sintered. Thus, in accordance with necessity, the blocklike sintered body may be milled with a milling process.

For the milling process (rough milling), for example, a stamping mill or the like is used. Thereafter, the milling process may be further performed by an automatic mortar or a dry ball mill to form particles having an average particle size about 10 μm to 100 μm. Here, the “average particle size” means a value obtained by a measurement using a laser diffraction/scattering method. Hereinafter, the average particle size of the powder means the measured value by a similar method.

When further fine and uniform particles are to be obtained, for example, the average particle size of the powder can be refined to 0.5 μm to 50 μm by using a wet ball mill in which alcohol (for example, isopropyl alcohol) expressed as CₙH₂ₙ₊₁OH (“n” is integer more than or equal to 3) is used as solvent, or a circular bead mill or the like.

The calcinated powder is prepared by the above step.

### (Step S120: Sintering Step)

Next, as is explained as follows, by holding the body to be processed including the obtained calcinated powder at a high temperature, the electrical conductive mayenite compound is directly manufactured.

For the body to be processed including the calcinated powder, the calcinated powder, which is the powder prepared in step S110, may be used as it is without molding. Alternatively, a compact body including the calcinated powder prepared in step S110 may be used as the body to be processed.

A method of forming the compact body is not specifically limited and various known methods may be used to form the compact body. For example, the compact body may be prepared by pressure molding of a molding material that is the powder prepared in step S110 or a kneaded body including the powder.

The molding material includes binder, lubricant, plasticizer or solvent, in accordance with necessity. As the binder, for example, polystyrene, polyethylene, polyvinyl butyral, EVA (ethene vinyl acetate) resin, EEA (ethene ethyl acrylate) resin, acrylic resin, cellulosic resin (nitrocellulose, ethyl cellulose), polyethylene oxide, or the like may be used. As the lubricant, wax or stearic acid may be used. As the plasticizer, phthalic acid ester may be used. As the solvent, aromatic compound such as toluene, xylene or the like, butyl acetate, terpineol, butyl carbitol acetate, alcohol expressed by a chemical formula CₙH₂ₙ₊₁OH (n=1 to 4) (isopropyl alcohol, for example), or the like may be used.

By sheet forming, extrusion molding, or injection molding of the molding material, the compact body can be obtained. The injection molding, by which near net shape manufacturing is possible, in other words, a shape closer to a final product can be productivity manufactured, is preferable.

In the injection molding, a compact body with a desired shape can be obtained by preparing a molding material by previously performing heat kneading of the calcinated powder and the binder, and inputting the molding material to an injection molding device. For example, by heat kneading the calcinated powder with the binder and cooling it, pellet or powder molding material having a size about 1 to 10 mm is obtained. In the heat kneading, a labo plastomill or the like is used, aggregation of the powder is released by shear stress and the binder is coated on a primary particle of the powder. The molding material is input to the injection molding device and heated to 120 to 250° C. to have the binder express fluidity. The compact body with the desired shape can be obtained by previously heating the mold to 50 to 80° C. and inputting the material to the mold at a pressure of 3 to 10 MPa.

Alternatively, a compact body with a desired shape may be formed by inputting the above described powder prepared in step 5110, or the kneaded body including the powder to the mold, and pressing the mold. For pressing the mold, for example, a cold isostatic pressing (CIP) process may be used. The pressure at the CIP process is not specifically limited, but for example, within a range of 50 to 200 MPa.

Further, when the compact body is prepared and the compact body includes the solvent, the compact body may be previously held at a temperature range of 50° C. to 200° C. for about 20 minutes to 2 hours to vaporize and remove the solvent. Further, when the compact body includes the binder, it is preferable to previously retain the compact body at a temperature range of 200 to 800° C. for about 30 minutes to 6 hours, or increase the temperature 50° C./hour to remove the binder. Alternatively, both of the processes may be performed at the same time.

Next, the body to be processed is treated with a high temperature treatment under reducing atmosphere. With this, calcium oxide and aluminum oxide in the calcinated powder react with each other to generate the mayenite compound, and the mayenite compound is reduced to form the electrical conductive mayenite compound.

Here, as described above, in the first embodiment, the body to be processed is placed in the presence of carbon monoxide gas and aluminum vapor supplied from the aluminum vapor source.

The high temperature treatment of the body to be processed is performed under reducing atmosphere. The “reducing atmosphere” is a generic name of atmosphere in which the partial pressure of oxygen in the environment is less than or equal to 10⁻³ Pa, and the environment may be inert-gas atmosphere, or reduced pressure environment (vacuum environment whose pressure is less than or equal to 100 Pa, for example). The partial pressure of oxygen is, preferably, less than or equal to 10⁻⁵ Pa, more preferably, less than or equal to 10⁻¹⁰ Pa, and furthermore preferably, less than or equal to 10⁻¹⁵ Pa.

The aluminum vapor source is not specifically limited, but may be, for example, an aluminum particle layer. Further, the aluminum vapor source may be aluminum which is a part of a composite material such as AlSiC (composite of aluminum and silicon carbide). Here, as described above, it should be noted that the body to be processed is placed in the presence of aluminum vapor without directly contacting the aluminum vapor source.

The carbon monoxide gas may be provided from outside to the environment where the body to be processed is placed, but it is preferable to place the body to be processed in a container containing carbon. A carbon container may be used or a carbon sheet may be placed in the environment.

The heat treatment may be performed at a state where the body to be processed and the aluminum layer are placed in a carbon container with a cover in order to supply carbon monoxide gas and aluminum vapor, for example. Here, it is preferable that the aluminum vapor source and the carbon container do not directly contact each other. This is because if both materials are held at a high temperature while contacting each other, both the materials react with each other at a contacting portion, and it becomes difficult to supply a sufficient amount of aluminum vapor and carbon monoxide gas to the reaction environment. The aluminum vapor source and the carbon container may be separated by a separator such as alumina or the like.

A method of adjusting the reaction environment to reducing atmosphere when performing the high temperature treatment on the body to be processed is not specifically limited.

For example, the container containing carbon may be placed at vacuum atmosphere whose pressure is less than or equal to 100 Pa. In this case, the pressure is, preferably, less than or equal to 60 Pa, more preferably, less than or equal to 40 Pa, and furthermore preferably, less than or equal to 20 Pa.

Alternatively, inert-gas atmosphere (however, except nitrogen gas) in which partial pressure of oxygen is less than or equal to 1000 Pa may be supplied to the container containing carbon. At this time, the partial pressure of oxygen in the supplied inert-gas atmosphere is, preferably, less than or equal to 100 Pa, more preferably, less than or equal to 10 Pa, furthermore preferably, less than or equal to 1 Pa, and in particularly preferably, less than or equal to 0.1 Pa.

The inert-gas atmosphere may be an argon gas atmosphere or the like. However, it is not preferable to use nitrogen gas as the inert-gas in the present invention. Nitrogen gas reacts with aluminum vapor that exists in the reaction environment in the invention to generate aluminum nitride. Thus, if aluminum nitride is generated, aluminum vapor necessary for reducing the mayenite compound is hardly supplied.

The process temperature is within a range of 1220° C. to 1350° C., specifically, preferably, within a range of 1270° C. to 1350° C., and more preferably, within a range of 1310° C. to 1350° C. If the process temperature is less than 1220° C., there is a possibility that the reaction between calcium oxide and aluminum oxide does not sufficiently proceed. Further, if the process temperature is more than 1350° C., the electron density may be lowered. Specifically, when the process temperature is within a range of 1270° C. to 1350° C., it is easy to obtain the electrical conductive mayenite compound whose electron density is more than or equal to 7.0×10²⁰ cm⁻³, and when the process temperature is within a range of 1310° C. to 1350° C., it is easy to obtain the electrical conductive mayenite compound whose electron density is more than or equal to 1.0×10²¹ cm⁻³.

The high temperature holding time for the body to be processed is, preferably, within a range of 30 minutes to 50 hours, more preferably, within a range of 2 hours to 40 hours, furthermore preferably, within a range of 3 hours to 30 hours, and at most preferably 2 hours to 8 hours. If the holding time for the body to be processed is less than 30 minutes, there is a possibility that the electrical conductive mayenite compound with a high electron density cannot be sufficiently obtained, and in addition, sintering is insufficient so that the obtained sintered body may be easily broken. Further, there is not a particular problem even when the holding time is made longer; however, preferably, the holding time is less than or equal to 24 hours for an efficient process.

With the above step, the electrical conductive mayenite compound whose electron density is more than or equal to 3.0×10²⁰ cm⁻³ can be obtained.

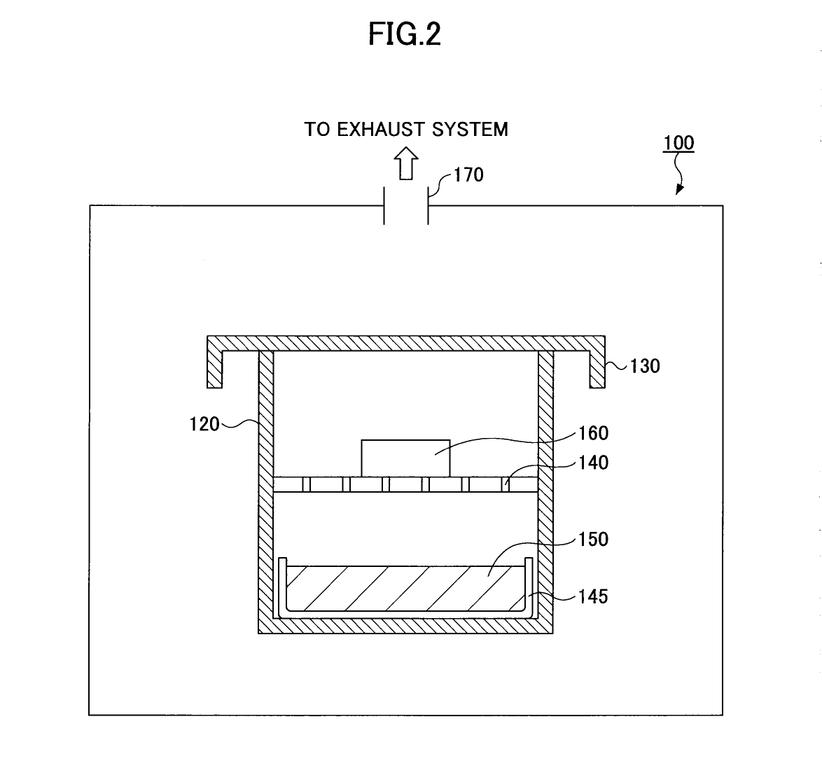

FIG. 2 is a view schematically illustrating an example of an apparatus that is used when performing a high temperature treatment on the body to be processed.

The entirety of an apparatus 100 is configured with a heat-resisting closed container, and an exhaust port 170 is connected to an exhaust system.

The apparatus 100 includes a carbon container 120 whose upper portion is opened, a carbon cover 130 placed on an upper portion of the carbon container 120, and a partition plate 140 placed in the carbon container 120, in the heat-resisting closed container. A metal aluminum powder layer 150 is placed on a heat-resisting tray (an alumina tray, for example) 145 that is mounted at a bottom portion of the carbon container 120, as an aluminum vapor source.

A body to be processed 160 is placed on an upper portion of the partition plate 140. The partition plate 140 has a structure that the aluminum vapor from the layer 150 can reach the body to be processed 160. Further, it is necessary to form the partition plate 140 with a material that does not react with aluminum vapor or the body to be processed 160 when performing the high temperature treatment. For example, the partition plate 140 is an alumina plate provided with a lot of through-holes.

The carbon container 120 and the carbon cover 130 function as a supply source of carbon monoxide gas when performing the high temperature treatment on the body to be processed 160. It means that when the body to be processed 160 is held at a high temperature, carbon monoxide gas is generated from the carbon container 120 and the carbon cover 130.

When the body to be processed 160 is held at the high temperature using the apparatus 100, the mayenite compound is generated by a reaction between calcium oxide and aluminum oxide in the calcinated powder. The free oxygen ions in the cages of the mayenite compound are reduced by aluminum vapor at the same time as the mayenite compound is generated, by the following reaction.

3O²⁻+2Al→6e⁻+Al₂O₃ equation (1)

Thus, by holding the body to be processed 160 at the high temperature, the electrical conductive mayenite compound is directly formed and is sintered.

Here, the apparatus structure illustrated in FIG. 2 is just an example, and it should be apparent for those skilled in the art to perform a high temperature treatment on the body to be processed using other apparatuses.

In the first embodiment, when the compact body including the calcinated powder, as the body to be processed including the calcinated powder, is treated with a high temperature treatment under reducing atmosphere, a sintered body of the electrical conductive mayenite compound with a high density can be obtained. The relative density of the obtained sintered body is, preferably, more than or equal to 90%, more preferably, more than or equal to 92%, furthermore preferably, more than or equal to 95%, and particularly preferably, more than or equal to 97%. The higher the relative density is, the harder it is for the sintered body of the electrical conductive mayenite compound to be broken by shock or thermal stress.

When the process temperature when performing a high temperature treatment on the body to be processed under reducing atmosphere is within a range of 1270° C. to 1350° C., it is easy to obtain an electrical conductive mayenite compound whose relative density is more than or equal to 90%, and when the process temperature is within a range of 1310° C. to 1350° C., it is easy to obtain an electrical conductive mayenite compound whose relative density is more than or equal to 97%.

### Second Embodiment

Next, second embodiment is explained.

In the second embodiment, when manufacturing the electrical conductive mayenite compound, the high electrical conductive mayenite compound can be obtained by placing the mayenite compound, which is the body to be processed, under carbon monoxide gas and aluminum vapor within a temperature range of 1230° C. to 1415° C. without contacting the aluminum source.

According to the manufacturing method of the second embodiment, by presenting carbon monoxide gas and aluminum vapor in an environment where the mayenite compound is placed, aluminum carbide is mainly formed at a surface of the mayenite compound. As aluminum carbide has a low affinity with the mayenite compound, which is oxide, the aluminum carbide does not adhere to the mayenite compound. Further, as the melting point of aluminum carbide is higher than that of the mayenite compound, aluminum carbide is not sintered. Thus, the surface of the mayenite compound is always kept being exposed to aluminum vapor and the free oxygen in the cages of the mayenite compound is at a state capable of being continuously extracted. Therefore, it is possible to obtain the high electrical conductive mayenite compound with a sufficiently high electron density within a short period.

### (Method of Manufacturing High Electrical Conductive Mayenite Compound of Second Embodiment)

The manufacturing method of the second embodiment is explained in detail with reference to drawings.

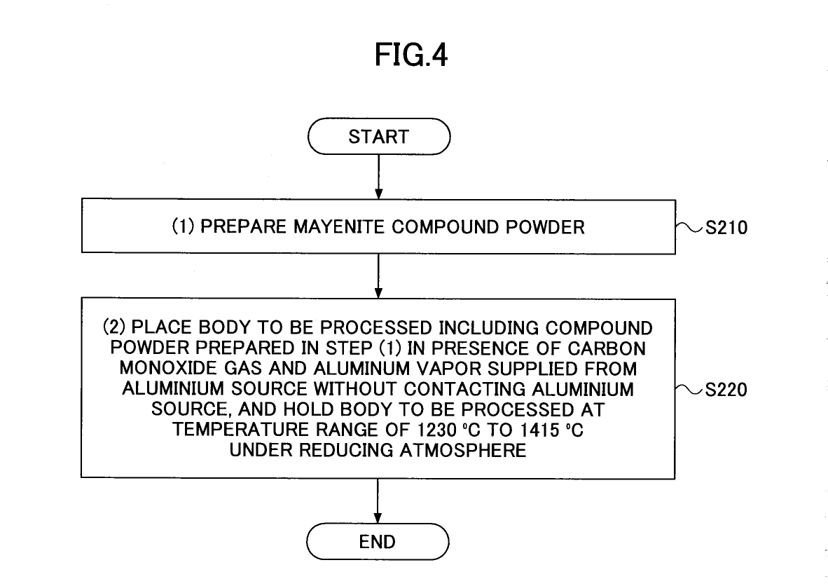

FIG. 4 illustrates a method of manufacturing the high electrical conductive mayenite compound of the second embodiment.

As illustrated in FIG. 4, the method of the second embodiment includes,

(1) a step of preparing a mayenite compound powder (step S210), and
(2) a step of placing a body to be processed including the compound powder prepared in the step (1) in the presence of carbon monoxide gas and aluminum vapor supplied from an aluminum source without contacting the aluminum source, and holding the body to be processed at a temperature range of 1230° C. to 1415° C. under reducing atmosphere (step S220).

Hereinafter, each of the steps is explained. (Step S210: Preparing step of mayenite compound powder)

First, the mayenite compound powder is prepared. The mayenite compound powder is synthesized and manufactured by heating a raw material powder at a high temperature as follows.

First, a raw material powder for synthesizing the mayenite compound powder is prepared.

The raw material powder is prepared such that the ratio of calcium (Ca) and aluminum (Al) becomes 12.6:6.4 to 11.7:7.3 based on molar ratio as converted to CaO:Al₂O₃. It is preferable that CaO:Al₂O₃ (molar ratio) is about 12:7.

Here, the compound used for the raw material powder is not specifically limited as long as the ratio is held.

It is preferable that the raw material powder includes calcium aluminate, or, at least two compounds selected from a group consisting of a calcium compound, an aluminum compound and calcium aluminate. The raw material powder may be, for example, a mixed powder including a calcium compound and an aluminum compound. The raw material powder may be, for example, a mixed powder including a calcium compound and calcium aluminate. Further, the raw material powder may be, for example, a mixed powder including an aluminum compound and calcium aluminate. Further, the raw material powder may be, for example, a mixed powder including a calcium compound, an aluminum compound and calcium aluminate. Further, the raw material powder may be, for example, a mixed powder including only calcium aluminate.

For the calcium compound, calcium carbonate, calcium oxide, calcium hydroxide, calcium hydrogencarbonate, calcium sulfate, calcium metaphosphate, calcium oxalate, calcium acetate, calcium nitrate, calcium halide or the like may be used. Among these, calcium carbonate, calcium oxide, and calcium hydroxide are preferably used.

For the aluminum compound, aluminum hydroxide, aluminum oxide, aluminum sulfate, aluminum nitrate, aluminum halide or the like may be used. Among these, aluminum hydroxide and aluminum oxide are preferably used.

Next, the prepared raw material powder is held at a high temperature and the mayenite compound is synthesized. The synthesizing may be performed under inert-gas atmosphere or under vacuum; however, it is preferable to be performed under air.

The synthesizing temperature is not specifically limited; but, for example, is preferably within a range of 1200° C. to 1415° C., more preferably, within a range of 1250° C. to 1400° C., and furthermore preferably within a range of 1300° C. to 1350° C. When it is synthesized within a temperature range of 1200° C. to 1415° C., the mayenite compound including a large amount of a C12A7 crystalline structure can be easily obtained. When the synthesizing temperature is too low, there is a possibility that the amount of the C12A7 crystalline structure becomes small. On the other hand, when the synthesizing temperature is too high to exceed the melting point of the mayenite compound, there is a possibility that the amount of the C12A7 crystalline structure becomes small.

The high temperature holding time is not specifically limited, and this varies in accordance with a synthesizing amount, holding temperature or the like. The holding time is, for example, 1 hour to 12 hours. The holding time is, for example, preferably, 2 hours to 10 hours, and more preferably, 4 hours to 8 hours. By holding the raw material powder at a high temperature for more than or equal to 2 hours, a solid phase reaction proceeds sufficiently to obtain a uniform mayenite compound.

The mayenite compound obtained by the synthesizing has a blocklike structure in which a part or all is sintered. The blocklike mayenite compound is processed with a milling process by a stamping mill or the like, for example, to be a size about 5 mm. Further, the mayenite compound may be processed with a milling process by an automatic mortar or a dry ball mill to form particles having an average particle size of about 10 μm to 100 μm. Here, the “average particle size” means a value obtained by a measurement using a laser diffraction/scattering method. Hereinafter, the average particle size of the powder means the measured value by a similar method.

When further fine and uniform particles are to be obtained, for example, the average particle size of the powder can be refined to 0.5 μm to 50 μm by using a wet ball mill in which alcohol (for example, isopropyl alcohol) expressed as CₙH₂ₙ₊₁OH (“n” is integer more than or equal to 3) is used as solvent, or a circular bead mill or the like. Water cannot be used as solvent. This is because the mayenite compound is a component of alumina cement and easily reacts with water to generate hydrate.

The mayenite compound powder is prepared by the above step.

The mayenite compound prepared as a powder may be an electrical conductive mayenite compound. This is because the electrical conductive mayenite compound has a better pulverizability than a non-electrical conductive compound. Here, even when the electrical conductive mayenite compound powder is used, there is a case where the compound powder is oxidized to be a non-electrical conductive mayenite compound when preparing the body to be processed (specifically, the compact body) in a subsequent step. The electrical conductive mayenite compound whose electron density is less than 3×10²⁰ cm⁻³ is preferably prepared.

A synthesizing method of the electrical conductive mayenite compound is not specifically limited, but the following methods may be used. For example, a method of manufacturing by putting a mayenite compound in a carbon container with a cover and performing a heat treatment at 1600° C. (WO 2005/000741), a method of manufacturing by putting a mayenite compound in a carbon container with a cover and performing a heat treatment at 1300° C. in nitrogen (WO 2006/129674), a method of manufacturing by putting a powder such as calcium aluminate or the like made from a calcium carbonate powder and an aluminum oxide powder in a carbon crucible with a cover and performing a heat treatment at 1300° C. in nitrogen (WO 2010/041558), a method of manufacturing a powder obtained by mixing a calcium carbonate powder and an aluminum oxide powder in a carbon crucible with a cover and performing a heat treatment at 1300° C. in nitrogen (Japanese Laid-open Patent Publication 2010-132467) or the like may be used.

A method of grinding the electrical conductive mayenite compound is similar to the method of grinding the mayenite compound.

With the above step, the electrical conductive mayenite compound powder is prepared. Here, a mixed powder of the mayenite compound and the electrical conductive mayenite compound may be used.

(Step S220: Sintering step)

Next, as is explained as follows, by holding the body to be processed including the obtained mayenite compound powder at a high temperature, the high electrical conductive mayenite compound is manufactured as oxygen ions in the cages of the mayenite compound are substituted for by electrons as well as the mayenite compound powder is sintered.

For the body to be processed including the mayenite compound powder, the powder prepared in step S210 may be used as it is. However, in general, a compact body including the mayenite compound powder prepared in step S210 is used as the body to be processed.

A method of forming the compact body is not specifically limited and various known methods may be used to form the compact body. For example, the compact body may be prepared by pressure molding of a molding material that is the powder prepared in step S210 or a kneaded body including the powder.

The molding material includes binder, lubricant, plasticizer or solvent, in accordance with necessity. As the binder, for example, polystyrene, polyethylene, polyvinyl butyral, EVA (ethene vinyl acetate) resin, EEA (ethene ethyl acrylate) resin, acrylic resin, cellulosic resin (nitrocellulose, ethyl cellulose), polyethylene oxide, or the like may be used. As the lubricant, wax or stearic acid may be used. As the plasticizer, phthalic acid ester may be used. As the solvent, aromatic compounds such as toluene, xylene or the like, butyl acetate, terpineol, butyl carbitol acetate, alcohol expressed by a chemical formula CₙH₂ₙ₊₁OH (n=1 to 4) (isopropyl alcohol, for example), or the like may be used. If water is used as the solvent, there is a possibility that stable slurry cannot be obtained as the mayenite compound causes a chemical reaction by hydration. Alcohol of n=1, 2 (ethanol, for example) has also a tendency to cause hydration, so that alcohol of n=3, 4 is preferable.

By sheet forming, extrusion molding, or injection molding of the molding material, a compact body can be obtained. The injection molding, by which near net shape manufacturing is possible, in other words, a shape closer to a final product can be productivity manufactured, is preferable.

In the injection molding, a compact body with a desired shape can be obtained by preparing a molding material by previously performing a heat kneading of the mayenite compound and the binder, and inputting the molding material to an injection molding device. For example, by heat kneading the mayenite compound with the binder and cooling it, pellet or powder molding material having a size about 1 to 10 mm is obtained. In the heat kneading, a labo plastomill or the like is used, aggregation of the powder is released by shear stress and the binder is coated on primary particles of the powder. The molding material is input to the injection molding device and heated to 120 to 250° C. to have the binder express fluidity. A compact body with a desired shape can be obtained by previously heating the mold to 50 to 80° C. and inputting the material to the mold at a pressure of 3 to 10 MPa.

Alternatively, a compact body with a desired shape may be formed by inputting the above described prepared powder or the kneaded body to the mold, and pressing the mold. For pressing the mold, for example, a cold isostatic pressing (CIP) process may be used. The pressure at the CIP process is not specifically limited, but for example, within a range of 50 to 200 MPa.

Further, when the compact body is prepared and the compact body includes the solvent, the compact body may be previously held at a temperature range of 50° C. to 200° C. for about 20 minutes to 2 hours to vaporize and remove the solvent. Further, when the compact body includes the binder, it is preferable to previously retain the compact body at a temperature range of 200 to 800° C. for about 30 minutes to 6 hours, or increase the temperature for 50° C./hour to remove the binder. Alternatively, both of the processes may be performed at the same time.

Next, the body to be processed is treated with a high temperature treatment under a reducing atmosphere. With this, calcium oxide and aluminum oxide in the calcinated powder react with each other to generate the mayenite compound, and the mayenite compound is reduced to form the electrical conductive mayenite compound.

Here, as described above, in the second embodiment, the body to be processed is placed in the presence of the carbon monoxide gas and aluminum vapor supplied from the aluminum vapor source.

The high temperature treatment of the body to be processed is performed under reducing atmosphere. The partial pressure of oxygen is, preferably, less than or equal to 10⁻⁵ Pa, more preferably, less than or equal to 10⁻¹⁰ Pa, and furthermore preferably, less than or equal to 10⁻¹⁵ Pa.

The aluminum vapor source is not specifically limited, but may be, for example, an aluminum particle layer. Further, the aluminum vapor source may be aluminum which is a part of a composite material such as, AlSiC (composite of aluminum and silicon carbide). Here, as described above, it should be noted that the body to be processed is placed in the presence of aluminum vapor without directly contacting the aluminum vapor source.

The carbon monoxide gas may be provided from outside to the environment where the body to be processed is placed, but it is preferable to place the body to be processed in a container containing carbon. A carbon container may be used or a carbon sheet may be placed in the environment.

The heat treatment may be performed at a state where the body to be processed and the aluminum layer are placed in a carbon container with a cover in order to supply carbon monoxide gas and aluminum vapor, for example. Here, it is preferable that the aluminum vapor source and the carbon container do not directly contact each other. This is because if both materials are held at a high temperature while contacting each other, both the materials react with each other at a contacting portion, and it becomes difficult to supply a sufficient amount of aluminum vapor and carbon monoxide gas to the reaction environment. The aluminum vapor source and the carbon container may be separated by a separator made of such as alumina or the like.

A method of adjusting the reaction environment to reducing atmosphere when performing the high temperature treatment on the body to be processed is not specifically limited.

For example, the container containing carbon may be placed at vacuum atmosphere whose pressure is less than or equal to 100 Pa. In this case, the temperature is, preferably, less than or equal to 60 Pa, more preferably, less than or equal to 40 Pa, and furthermore preferably, less than or equal to 20 Pa.

Alternatively, inert-gas atmosphere (however, except nitrogen gas) in which partial pressure of oxygen is less than or equal to 1000 Pa may be supplied to the container containing carbon. At this time, the partial pressure of oxygen in the supplied inert-gas atmosphere is, preferably, less than or equal to 100 Pa, more preferably, less than or equal to 10 Pa, furthermore preferably, less than or equal to 1 Pa, and in particularly preferably, less than or equal to 0.1 Pa.

The inert-gas atmosphere may be an argon gas atmosphere or the like. However, it is not preferable to use nitrogen gas as the inert-gas in the present invention. Nitrogen gas reacts with aluminum vapor that exists in the reaction environment in the invention to generate aluminum nitride. Thus, if aluminum nitride is generated, aluminum vapor necessary for reducing the mayenite compound is hardly supplied.

The process temperature is within a range of 1230° C. to 1415° C., specifically, preferably, within a range of 1250° C. to 1370° C., and preferably within a range of 1250° C. to 1320° C. If the process temperature is less than 1230° C., there is a possibility that the sufficient electrical conductivity is not given to the mayenite compound. Further, if the process temperature is more than 1415° C., which exceeds the melting point of the mayenite compound, the crystalline structure decomposes to lower the electron density. It is preferable to perform the heat treatment at less than or equal to 1370° C. in order to obtain an electrical conductive mayenite compound with a desired shape. Further, it is more preferable to perform the heat treatment at less than or equal to 1320° C. so that a phenomenon that the surface aluminum carbide layer becomes too thick can be suppressed.

The high temperature holding time for the body to be processed is, preferably, within a range of 5 minutes to 48 hours, more preferably, within a range of 30 minutes to 24 hours, furthermore preferably, within a range of 1 hour to 12 hours, and at most preferably, 2 hours to 8 hours. When the holding time for the body to be processed is less than 5 minutes, there is a possibility that the electrical conductive mayenite compound with a sufficient high electron density cannot be obtained and sintering is not sufficient so that the obtained sintered body may easily broken. Further, even when the holding time becomes longer, there is no problem in its characteristics; however, it is preferable that the holding time is less than or equal to 24 hours so that a desired shape of the mayenite compound can be easily held. Further, it is more preferable that the holding time is less than or equal to 12 hours so that a phenomenon that the surface aluminum carbide layer becomes too thick can be suppressed.

When aluminum carbide is generated, different from a general oxide layer, it can be easily removed from the surface of the electrical conductive mayenite compound just by slightly rubbing. Thus, when aluminum and carbon monoxide are used, a new surface of the obtained high electrical conductive mayenite compound can be easily exposed. At this time, the obtained high electrical conductive mayenite compound can be used as the electrode material almost as it is.

With the above step, the high electrical conductive mayenite compound whose electron density is more than or equal to 3.0×10²⁰ cm⁻³ can be obtained.

Here, the above described apparatus illustrated in FIG. 2 may be used when performing the manufacturing method of the second embodiment.

### EXAMPLE

Next, examples are explained.

### Example 1

The electrical conductive mayenite compound was manufactured by the following method.

### (Syntheses of Calcinated Powder)

First, 313.5 g of a calcium carbonate (CaCO₃) powder and 186.5 g of an aluminum oxide (Al₂O₃) powder were mixed such that calcium oxide (CaO):aluminum oxide (Al₂O₃) became 12:7 by molar ratio conversion.

Next, the mixed powder was input in an alumina container to be heated in air to 1000° C. at a temperature rising rate of 300° C./hour and held at 1000° C. for 6 hours. Thereafter, the mixed powder was cooled at a cooling rate of 300° C./hour to obtain about 362 g of white powder.

Next, the white powder was grinded by an alumina automatic mortar mill to obtain a calcinated powder. By measuring the granularity of the obtained calcinated powder by a laser diffraction/scattering method (SALD-2100, manufactured by Shimadzu Corporation), the average particle size of the calcinated powder was 20 μm.

### (Molding of Calcinated Powder)

The calcinated powder (12 g) obtained by the above described method was spread in a mold having a length 40 mm×a width 20 mm×a height 30 mm. The molding was performed with a uni-axial press at a 10 MPa for 1 minute. Further, the molding was performed with cold isostatic pressing at a pressure of 180 MPa.

With this, a compact body having a size of a length about 40 mm×a width about 20 mm×a height about 10 mm was obtained.

### (Manufacturing Sintered Body of Electrical Conductive Mayenite Compound)

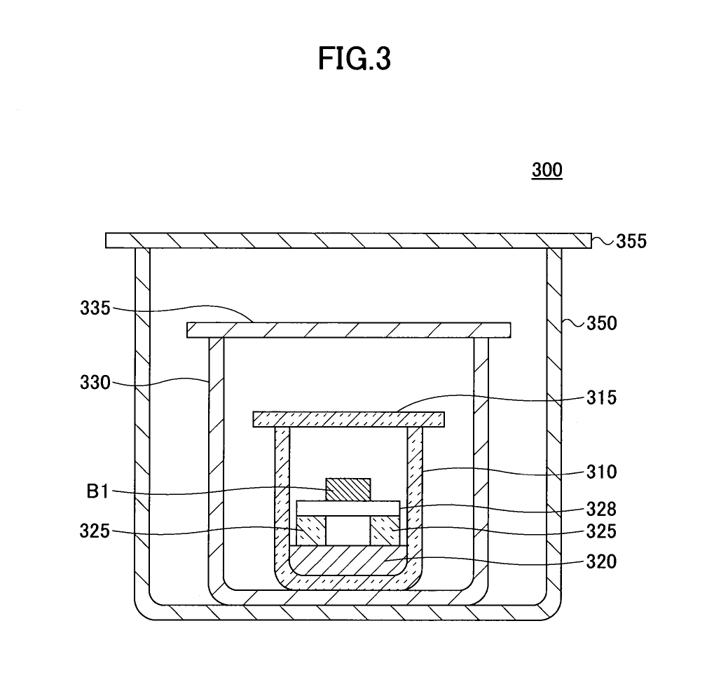

Next, the compact body is sintered with a sintering process at a high temperature using the apparatus illustrated in FIG. 3 to manufacture the electrical conductive mayenite compound.

FIG. 3 illustrates an apparatus that was used for a sintering process of the compact body. As illustrated in FIG. 3, an apparatus 300 includes an alumina container 310 with an alumina cover 315, a first carbon container 330 with a carbon cover 335, and a second carbon container 350 with a carbon cover 355. Further, an aluminum layer 320 configured by spreading 3 g of a metal aluminum powder is placed at a bottom surface of the alumina container 310. The aluminum layer 320 functions as the aluminum vapor source that generates aluminum vapor when the apparatus 300 is heated at a high temperature.

The alumina container 310 has a substantially cylindrical shape whose external diameter is 40 mm×internal diameter is 38 mm×height is 40 mm. Further, the first carbon container 330 has a substantially cylindrical shape whose external diameter is 60 mm×internal diameter is 50 mm×height is 60 mm. The second carbon container 350 has a substantially cylindrical shape whose external diameter is 80 mm×internal diameter is 70 mm×height is 75 mm.

The apparatus 300 was used as follows.

First, the above described compact body was cut by a commercially available cutter to a rectangular shape whose length is 20 mm×width is 20 mm×thickness is 10 mm.

Next, this compact body B1 was placed in the alumina container 310. At this time, two alumina blocks 325 having the same shape were placed on the aluminum layer 320, and an alumina plate 328 whose thickness is 1 mm was further placed on the alumina blocks 325. After placing the compact body B1 on the alumina plate 328, the cover 315 was placed on the alumina container 310. Under this state, the compact body B1 did not directly contact the aluminum layer 320.

Next, the apparatus 300 was provided in an atmosphere adjustable electric furnace. Further, the furnace was evacuated by a rotary pump. Thereafter, after the pressure in the furnace became less than or equal to 20 Pa, and the apparatus 300 was started to be heated to 1320° C. at a temperature rising rate of 300° C./hour. After holding the apparatus 300 for 6 hours under this state, the apparatus 300 was cooled to room temperature at a temperature decreasing rate of 300° C./hour.

Here, the partial pressure of oxygen thermodynamically calculated from the equilibrium constant of the oxidation-reduction reaction of aluminum and carbon at 1300° C. was 1.6×10⁻²⁰ Pa. Thus, it is estimated that the partial pressure of oxygen in the environment in which the compact body was exposed was about 1.6×10⁻²⁰ Pa by calculation.

With this process, the compact body B1 was sintered and a black material whose surface was slightly white (hereinafter, referred to as a black material “C1”) was obtained. The black material C1 was a rectangular solid having a length 16 mm×a width 16 mm×a thickness 8 mm, and the relative density of which was 97.8%.

In order to obtain a measurement sample for electron density, the black material C1 was milled with rough milling by an alumina automatic mortar mill. First, the black material C1 was grinded by the alumina mortar mill to carefully remove the slightly white portion at the surface and the rough milling was performed only using the black portion.

The obtained powder was dark brown. As a result of X-ray diffraction analysis, it was revealed that the powder only included the C12A7 structure. Further, the electron density obtained from a peak position of the light diffusion reflection spectrum of the obtained powder was 1.0×10²¹ cm⁻³ and the electrical conductivity of which was 11 S/cm. With this, it was confirmed that the black material C1 was the sintered body of the high electrical conductive mayenite compound.

The condition in the sintering step and the evaluation result of the obtained sintered body of the example 1 are illustrated in Table 1.

TABLE 1

| | SINTERING STEP | | | | EVALUATED RESULT | | |
|---|---|---|---|---|---|---|---|
| | | | | HOLDING | | RELATIVE | ELECTRON |
| | BODY TO BE | | TEMPERATURE | TIME | SIZE OF BODY TO | DENSITY | DENSITY |
| EXAMPLE | PROCESSED | ENVIRONMENT | (° C.) | (h) | BE PROCESSED | (%) | (cm⁻³) |
| EXAMPLE 1 | COMPACT BODY | WITH C AND | 1320 | 6 | 16 mm × 16 mm × 8 mm | 97.8 | 1.0 × 10²¹ |
| | OF CALCINATED | Al VAPOR | | | | | |
| | POWDER | (BODY NOT | | | | | |
| EXAMPLE 2 | COMPACT BODY | CONTACT | 1230 | 6 | 18 mm × 18 mm × 9 mm | 87.4 | 6.6 × 10²⁰ |
| | OF CALCINATED | WITH Al | | | | | |
| | POWDER | SOURCE) | | | | | |
| EXAMPLE 3 | COMPACT BODY | | 1340 | 6 | 16 mm × 16 mm × 8 mm | 98.5 | 1.0 × 10²¹ |
| | OF CALCINATED | | | | | | |
| | POWDER | | | | | | |
| EXAMPLE 4 | COMPACT BODY | | 1300 | 6 | 16 mm × 16 mm × 8 mm | 91.0 | 1.0 × 10²¹ |
| | OF CALCINATED | | | | | | |
| | POWDER | | | | | | |
| EXAMPLE 5 | COMPACT BODY | | 1300 | 24 | 16 mm × 16 mm × 8 mm | 92.5 | 1.2 × 10²¹ |
| | OF CALCINATED | | | | | | |
| | POWDER | | | | | | |
| EXAMPLE 6 | COMPACT BODY | | 1300 | 48 | 16 mm × 16 mm × 8 mm | 93.0 | 1.2 × 10²¹ |
| | OF CALCINATED | | | | | | |
| | POWDER | | | | | | |
| EXAMPLE 7 | COMPACT BODY | | 1320 | 24 | 92 mm φ × 6 mm | 98.0 | 8.5 × 10²⁰ |
| | OF CALCINATED | | | | | | |
| | POWDER | | | | | | |
| EXAMPLE 8 | CALCINATED | | 1320 | 6 | — | — | 1.0 × 10²¹ |
| | POWDER | | | | | | |
| RELATIVE | COMPACT BODY | | 1200 | 6 | 19 mm × 19 mm × 9 mm | — | (UNUNIFORM) |
| EXAMPLE 1 | OF CALCINATED | | | | | | |
| | POWDER | | | | | | |
| RELATIVE | COMPACT BODY | | 1360 | 6 | — | — | 6.9 × 10¹⁹ |
| EXAMPLE 2 | OF CALCINATED | | | | | | |
| | POWDER | | | | | | |
| RELATIVE | COMPACT | WITHOUT | 1320 | 6 | 17 mm × 17 mm × 8 mm | 92.0 | 1.2 × 10¹⁹ |
| EXAMPLE 3 | BODY OF | C AND | | | | | |
| | CALCINATED | WITH Al | | | | | |
| | POWDER | VAPOR | | | | | |
| | | (BODY NOT | | | | | |
| | | CONTACT | | | | | |
| | | WITH Al | | | | | |
| | | SOURCE) | | | | | |
| RELATIVE | COMPACT | WITH C AND Al | 1320 | 2 | (UNABLE TO | — | — |
| EXAMPLE 4 | BODY OF | VAPOR (BODY | | | COLLECT) | | |
| | CALCINATED | CONTACT | | | | | |
| | POWDER | WITH Al | | | | | |
| | | SOURCE) | | | | | |
| RELATIVE | COMPACT | WITH C AND | 1320 | 2 | 17 mm × 17 mm × 8 mm | 96.0 | 3.3 × 10¹⁹ |
| EXAMPLE 5 | BODY OF | WITHOUT | | | | | |
| | CALCINATED | Al VAPOR | | | | | |
| | POWDER | | | | | | |

### Example 2

Similar to the method of the above described example 1, the electrical conductive mayenite compound was manufactured. However, in this example 2, the sintering temperature was 1230° C. in the above described step (manufacturing the electrical conductive mayenite compound). Other conditions were similar to those of the example 1.

With this, a black material whose surface was slightly white (hereinafter, referred to as a black material “C2”) was obtained after the above described step (manufacturing the electrical conductive mayenite compound). The black material C2 had a rectangular shape having a length 18 mm×a width 18 mm×a thickness 9 mm, and the relative density of which was 87.4%.

Further, as a result of X-ray diffraction of the powder obtained by grinding the black material C2 by the method similar to the example 1, it was revealed that the black material C2 only included the C12A7 structure and a slight amount of hetero-facies. The electron density of the black material C2 was 6.6×10²⁰ cm⁻³ and the electrical conductivity of which was 7 S/cm.

With this, it was confirmed that the black material C2 was the sintered body of the high electrical conductive mayenite compound.

The condition in the sintering step and the evaluation result of the obtained sintered body of the example 2 are illustrated in the above described Table 1.

### Example 3

Similar to the method of the above described example 1, the electrical conductive mayenite compound was manufactured. However, in this example 3, the sintering temperature was 1340° C. in the above described step (manufacturing the electrical conductive mayenite compound). Other conditions were similar to those of the example 1.

With this, a black material whose surface was pale yellow (hereinafter, referred to as a black material “C3”) was obtained after the above described step (manufacturing the sintered body of the electrical conductive mayenite compound). The black material C3 had a rectangular shape having a length 16 mm×a width 16 mm×a thickness 8 mm, and the relative density of which was 98.5%.

Further, as a result of X-ray diffraction of the powder obtained by grinding the black material C3 by the method similar to the example 1, it was revealed that the black material C3 only included the C12A7 structure and a slight amount of hetero-facies. The electron density of the black material C3 was 1.0×10²¹ cm⁻³ and the electrical conductivity of which was 11 S/cm.

With this, it was confirmed that the black material C3 was the sintered body of the high electrical conductive mayenite compound.

The conditions in the sintering step and the evaluation result of the obtained sintered body of the example 3 are illustrated in the above described Table 1.

### Example 4

Similar to the method of the above described example 1, the sintered body of the electrical conductive mayenite compound was manufactured. However, in this example 4, the sintering temperature was 1300° C. in the above described step (manufacturing the sintered body of the electrical conductive mayenite compound). Other conditions were similar to those of the example 1.

With this, a black material whose surface was pale yellow (hereinafter, referred to as a black material “C4”) was obtained after the above described step (manufacturing the sintered body of the electrical conductive mayenite compound). The black material C4 had a rectangular shape having a length 16 mm×a width 16 mm×a thickness 8 mm, and the relative density of which was 91.0%.

Further, as a result of X-ray diffraction of the powder obtained by grinding the black material C4 by the method similar to the example 1, it was revealed that the black material C4 only included the C12A7 structure and a slight amount of hetero-facies. The electron density of the black material C4 was 1.0×10²¹ cm⁻³, and the electrical conductivity of which was 11 S/cm.

With this, it was confirmed that the black material C4 was the sintered body of the high electrical conductive mayenite compound.

The conditions in the sintering step and the evaluation result of the obtained sintered body of the example 4 are illustrated in the above described Table 1.

### Example 5

Similar to the method of the above described example 1, the sintered body of the electrical conductive mayenite compound was manufactured. However, in this example 5, the sintering temperature was 1300° C. and the holding time was 24 hours in the above described step (manufacturing the sintered body of the electrical conductive mayenite compound). Other conditions were similar to those of the example 1.

With this, a black material whose surface was pale yellow (hereinafter, referred to as a black material “C5”) was obtained after the above described step (manufacturing the sintered body of the electrical conductive mayenite compound). The black material C5 had a rectangular shape having a length 16 mm×a width 16 mm×a thickness 8 mm, and the relative density of which was 92.5%.

Further, as a result of X-ray diffraction of the powder obtained by grinding the black material

C5 by the method similar to the example 1, it was revealed that the black material C5 only included the C12A7 structure and a slight amount of hetero-facies. The electron density of the black material C5 was 1.2×10²¹ cm⁻³ and the electrical conductivity of which was 13 S/cm.

With this, it was confirmed that the black material C5 was the sintered body of the high electrical conductive mayenite compound.

The condition in the sintering step and the evaluation result of the obtained sintered body of the example 5 are illustrated in the above described Table 1.

### Example 6

Similar to the method of the above described example 1, the sintered body of the electrical conductive mayenite compound was manufactured. However, in this example 6, the sintering temperature was 1300° C. and the holding time was 48 hours in the above described step (manufacturing the sintered body of the electrical conductive mayenite compound). Other conditions were similar to those of the example 1.

With this, a black material whose surface was pale yellow (hereinafter, referred to as a black material “C6”) was obtained after the above described step (manufacturing the sintered body of the electrical conductive mayenite compound). The black material C6 had a rectangular shape having a length 16 mm×a width 16 mm×a thickness 8 mm, and the relative density of which was 93.0%.

Further, as a result of X-ray diffraction of the powder obtained by grinding the black material C6 by the method similar to the example 1, it was revealed that the black material C6 only included the C12A7 structure and a slight amount of hetero-facies. The electron density of the black material C6 was 1.2×10²¹ cm⁻³ and the electrical conductivity of which was 13 S/cm.

With this, it was confirmed that the black material C6 was the sintered body of the high electrical conductive mayenite compound.

Here, by comparing the results of the example 5 and the example 6, it is revealed that the electron densities vary little for both examples. With this, it is considered that it is hard to further increase the electron density even when the sintering process time is set longer than 24 hours. Thus, in the light of reducing energy consumption, it is preferable to set the holding time to be less than or equal to 24 hours.

The condition in the sintering step and the evaluation result of the obtained sintered body of the example 6 are illustrated in the above described Table 1.

### Example 7

Similar to the method of the above described example 1, the sintered body of the electrical conductive mayenite compound was manufactured. However, in this example 7, a disciform mold having a diameter 110 mm×a height 30 mm was used instead of the rectangular solid mold having a length 40 mm×a width 20 mm×a height 30 mm, in the above described step (molding of the calcinated powder). With this, a compact body B7 having a diameter 100 mm φ×a height 8 mm was obtained.

Further, in the next step (manufacturing the sintered body of the electrical conductive mayenite compound), an apparatus to process this compact body B7 was structured as follows.

First, the compact body B7 was placed at a bottom portion of a first carbon container having a size of an internal diameter 190 mm φ×an external diameter 210 mm φ×a height 110 mm. Next, an alumina container including metal aluminum was placed at an upper portion of the compact body B7. A carbon cover was placed on the first carbon container under this state.

Next, the first carbon container was provided in a second carbon container having a size of an internal diameter 230 mm φ×an external diameter 250 mm φ×a height 140 mm. Further, a carbon cover was placed on the second container.

The apparatus thus structured was provided in an atmosphere adjustable electric furnace.

Further, the furnace was evacuated by a rotary pump. Thereafter, after the pressure in the furnace became less than or equal to 20 Pa, the apparatus was started to be heated to 1320° C. at a temperature rising rate of 300° C./hour. After holding the apparatus for 24 hours under this state, the apparatus was cooled to room temperature at a temperature decreasing rate of 300° C./hour.

With this, a black material whose surface was pale yellow (hereinafter, referred to as a black material “C7”) was obtained after the above described step (manufacturing the sintered body of the electrical conductive mayenite compound). The black material C7 had a disciform having a diameter 92 mm φ×a thickness 6 mm and the relative density of which was 98.0%.

Further, the black material C7 was analyzed by the similar method as the example 1.

Here, as the black material C7 has a relatively large size, when preparing powders, sampling was performed from two positions at a center portion and an outside portion of the black material C7. As a result of X-ray diffraction of the powders obtained by sampling from the two positions, it was confirmed that the black material C7 only included the C12A7 structure and a slight amount of hetero-facies at any positions.

Further, the electron density of the black material C7 was 8.5×10²⁰ cm⁻³ at any positions, and the electrical conductivity of which was 9 S/cm at any positions.

With this, it was confirmed that the black material C7 was the sintered body of the high electrical conductive mayenite compound in a uniform state.

The condition in the sintering step and the evaluation result of the obtained sintered body of the example 7 are illustrated in the above described Table 1.

### Example 8

Similar to the method of the above described example 1, the electrical conductive mayenite compound was manufactured. However, in this example 8, the above described method (molding of the calcinated powder) was omitted. It means that in the example 8, the compact body was not manufactured and the calcinated powder was placed on the alumina plate 328 in a form of powder. The weight of the calcinated powder was 3 g. Other conditions were similar to those of the example 1.

With this, a collapsed to be disciform and partially sintered black material whose surface was slightly white (hereinafter, referred to as a black material “C8”) was obtained after the above described step (manufacturing the electrical conductive mayenite compound). The black material C8 was easily broken. However, as it was easily broken, the relative density was not able to be measured.

Further, as a result of X-ray diffraction of the powder obtained by grinding the black material C8 by the method similar to the example 8, it was revealed that the black material C8 only included the C12A7 structure and a slight amount of hetero-facies. The electron density of the black material C8 was 1.0×10²¹ cm⁻³. The electrical conductivity was not able to be measured because the shape was unstable.

With this, it was confirmed that the black material C8 was the high electrical conductive mayenite compound.

### Relative Example 1

Similar to the method of the above described example 1, manufacturing the high electrical conductive mayenite compound was attempted. However, in this relative example 1, the sintering temperature was 1200° C. in the above described step (manufacturing the sintered body of the electrical conductive mayenite compound). Other conditions were similar as those of the example 1.

With this, a black material whose surface was slightly white (hereinafter, referred to as a black material “C9”) was obtained after the above described step (manufacturing the sintered body of the electrical conductive mayenite compound). The black material C9 had a rectangular shape having a length 19 mm×a width 19 mm×a thickness 9 mm.

It was revealed that inside of the black material C9 was white and reduction was insufficient by performing a rough milling in order to measure the electron density of the black material C9.

As such, in the relative example 1, the sintered body of the electrical conductive mayenite compound in a uniform state was not able to be obtained.

The condition in the sintering step and the evaluation result of the obtained sintered body of the relative example 1 are illustrated in the above described Table 1.

### Relative Example 2

Similar to the method of the above described example 1, the electrical conductive mayenite compound was manufactured. However, in this relative example 2, the sintering temperature was 1360° C. in the above described step (manufacturing the sintered body of the electrical conductive mayenite compound). Other conditions were similar to those of the example 1.

With this, a black material whose surface was black (hereinafter, referred to as a black material “C10”) was obtained after the above described step (manufacturing the sintered body of the electrical conductive mayenite compound). The black material C10 was largely deformed, adhered to the alumina plate and was not able to be separated from the alumina plate.

Thus, the alumina plate was broken, a part of the black material C10 was collected, and the electron density was measured. As a result of X-ray diffraction of the powder obtained by grinding the obtained sample, it was revealed that the black material C10 only included the C12A7 structure and a slight amount of hetero-facies. However, the electron density of the black material 010 was 6.9×10¹⁹ cm⁻³ and the electrical conductivity of which was 0.7 S/cm.

With this, it was confirmed that the black material C10 was not the sintered body of the high electrical conductive mayenite compound.

The condition in the sintering step and the evaluation result of the obtained sintered body of the relative example 2 are illustrated in the above described Table 1.

### Relative Example 3

Similar to the method of the above described example 1, the sintered body of the electrical conductive mayenite compound was manufactured. However, in this relative example 3, the carbon container with the cover was not used and only the alumina container with the cover was used in the above described step (manufacturing the sintered body of the electrical conductive mayenite compound). Further as the electric furnace, an alumina furnace core tube was used and the heat treatment was performed under a condition without carbon. Other conditions were similar to those of the example 1.

With this, a black material whose surface was slightly white and silvery-white (hereinafter, referred to as a black material “C11”) was obtained after the above described step (manufacturing the sintered body of the electrical conductive mayenite compound). The black material C11 had a rectangular shape having a length 17 mm×a width 17 mm×a thickness 8 mm, and the relative density was 92.0%.

As a result of X-ray diffraction of a powder obtained by grinding the obtained black material C11, it was revealed that the black material C11 only included the C12A7 structure and a slight amount of hetero-facies. Further, the electron density obtained from the light diffusion reflection spectrum of the obtained powder by Kubelka-Munk transformation was 1.2×10¹⁹ cm⁻³ and the electrical conductivity of which was 0.1 S/cm.

With this, it was confirmed that the black material C11 was not the sintered body of the high electrical conductive mayenite compound.

The condition in the sintering step and the evaluation result of the obtained sintered body of the relative example 3 are illustrated in the above described Table 1.

### Relative Example 4

Similar to the method of the above described example 1, the sintered body of the electrical conductive mayenite compound was manufactured. However, in this relative example, the compact body B1 was provided directly on the metal aluminum powder in the above described step (manufacturing the sintered body of the electrical conductive mayenite compound). Other conditions were similar to those of the example 1.

With this, a black material (hereinafter, referred to as a black material “C12”) was obtained after performing the above described step (manufacturing the sintered body of the electrical conductive mayenite compound). About half of the black material C12 was buried in the metal aluminum layer and was not able to be collected easily.

As such, by the relative example 4, it was revealed that a large effort was necessary to collect the sintered body so that it is not a realistic method of manufacturing the sintered body of the electrical conductive mayenite compound.

The condition in the sintering step and the evaluation result of the obtained sintered body of the relative example 4 are illustrated in the above described Table 1.

### Relative Example 5

Similar to the method of the above described example 1, the sintered body of the electrical conductive mayenite compound was manufactured. However, in this relative example 5, the metal aluminum layer was not provided in the above described step (manufacturing the sintered body of the electrical conductive mayenite compound). Other conditions were similar to those of the example 1.

With this, a black material whose surface was black (hereinafter, referred to as a black material “C13”) was obtained after the above described step (manufacturing the sintered body of the electrical conductive mayenite compound). The black material C13 had a rectangular shape having a length 17 mm×a width 17 mm×a thickness 8 mm, and the relative density of which was 96.0%.

As a result of X-ray diffraction of a powder obtained by grinding the black material C13, it was revealed that the black material C13 only included the C12A7 structure. However, the electron density obtained from the light diffusion reflection spectrum of the obtained powder by Kubelka-Munk transformation was 3.3×10¹⁹ cm⁻³ and the electrical conductivity of which was 0.2 S/cm. With this, it was confirmed that the black material C13 was not the sintered body of the high electrical conductive mayenite compound.

The condition in the sintering step and the evaluation result of the obtained sintered body of the relative example 5 are illustrated in the above described Table 1.

### Example 11

The high electrical conductive mayenite compound was manufactured by the following method.

### (Syntheses of Mayenite Compound)

313.5 g of a calcium carbonate (CaCO₃) powder and 186.5 g of an aluminum oxide (Al₂O₃) powder were mixed such that calcium oxide (CaO): aluminum oxide (Al₂O₃) became 12:7 by molar ratio conversion. Next, the mixed powder was heated to 1350° C. at a temperature rising rate of 300° C./hour in air and held at 1350° C. for 6 hours. Thereafter, the mixed powder was cooled at a cooling rate of 300° C./hour to obtain about 362 g of a white block body.

Next, after grinding the white block body by an alumina stamping mill to obtain a fragment having a size about 5 mm, further, the fragment was processed with rough milling by an alumina automatic mortar mill to obtain white particles (hereinafter, referred to as a particle “SA1”). By measuring the granularity of the obtained particles SA1 by a laser diffraction/scattering method (SALD-2100, manufactured by Shimadzu Corporation), the average particle size was 20 μm.

Next, 350 g of the particles SA1, 3 kg of zirconia balls having a diameter of 5 mm, and 350 ml of industrial EL grade isopropyl alcohol as a milling solvent were put in a 2 liter zirconia container, and milled with a ball mill milling process at a rotation speed of 94 rpm for 16 hours after placing a zirconia cover on the container.

After the process, the obtained slurry was filtered under suction to remove the milling solvent. Further, the remaining material was put into an oven at 80° C. and dried for 10 hours. With this, a white powder (hereinafter, referred to as a powder “SB1”) was obtained. As a result of X-ray diffraction analysis, it was confirmed that the obtained powder SB1 had the C12A7 structure. Further, by the above described laser diffraction/scattering method, it was revealed that the average particle size of the obtained powder SB1 was 3.3 μm.

### (Manufacturing Compact Body of Mayenite Compound)

The powder SB1 (13 g) obtained by the above described method was spread in a mold having a length 40 mm×a width 20 mm×a height 30 mm. The molding was performed with a uni-axial press at a pressure of 10 MPa for 1 minute. Further, the molding was performed with a cold isostatic pressing at a pressure of 180 MPa to obtain a compact body SC1 having a size of a length about 40 mm×a width about 20 mm×a height about 10 mm.

### (Manufacturing High Electrical Conductive Mayenite Compound)

Next, the compact body SC1 was sintered with a sintering process at a high temperature to manufacture the electrical conductive mayenite compound using the above described apparatus illustrated in FIG. 3.

In this example 11, the above described apparatus 300 was used as follows.

First, the above described compact body SC1 was cut by a commercially available cutter to a rectangular shape with length of 8 mm×width of 6 mm×thickness of 6 mm.

Next, the compact body SC1 was placed in the alumina container 310. At this time, two of the alumina blocks 325 having the same shape were placed on the aluminum layer 320, and the alumina plate 328 whose thickness was 1 mm was further placed on the alumina blocks 325. After placing the compact body SC1 on the alumina plate 328, the cover 315 was placed on the alumina container 310. Under this state, the compact body SC1 did not directly contact the aluminum layer 320.

Next, the apparatus 300 was placed in an atmosphere adjustable electric furnace. Further, the furnace was evacuated by a rotary pump. Thereafter, after the pressure in the furnace became less than or equal to 5 Pa, the apparatus 300 was started to be heated to 1250° C. at a temperature rising rate of 300° C./hour. After holding the apparatus 300 for 6 hours under this state, the apparatus 300 was cooled to room temperature at a temperature decreasing rate of 300° C./hour.

Here, the partial pressure of oxygen thermodynamically calculated from the equilibrium constant of the oxidation-reduction reaction of aluminum and carbon at 1300° C. was 1.6×10⁻²⁰ Pa. Thus, it is estimated that the partial pressure of oxygen in the environment in which the compact body SC1 was exposed at 1250° C. was less than 1.6×10⁻²⁰ Pa by calculation.

With this process, the compact body SC1 was sintered and a black material whose surface was slightly white (hereinafter, referred to as a black material “SD1”) was obtained. The relative density of the black material SD1 was 97.0%.

In order to obtain a measurement sample for electron density, the black material SD1 was milled with rough milling by an alumina automatic mortar mill. First, the black material SD1 was grinded by the alumina mortar mill to carefully remove the slightly white portion at the surface and the rough milling was performed only using the black portion.

The obtained powder was dark brown. As a result of X-ray diffraction analysis, it was revealed that the powder only included the C12A7 structure. Further, the electron density obtained from a peak position of the light diffusion reflection spectrum of the obtained powder was 1.6×10²¹ cm⁻³ and the electrical conductivity of which was 17 S/cm. With this, it was confirmed that the black material SD1 was the high electrical conductive mayenite compound.

### Example 12

Similar to the method of the above described example 11, the electrical conductive mayenite compound was manufactured. However, in this example 12, the sintering temperature was 1300° C. in the above described step (manufacturing the high electrical conductive mayenite compound). Other conditions were similar to those of the example 11.

Here, the partial pressure of oxygen thermodynamically calculated from the equilibrium constant of the oxidation-reduction reaction of aluminum and carbon at 1300° C. is 1.6×10⁻²⁰ Pa. Thus, it is estimated that the partial pressure of oxygen in the environment in which the compact body SC1 was exposed was about 1.6×10⁻²⁰ Pa by calculation, in the example 12.

With this, a black material whose surface was pale yellow (hereinafter, referred to as a black material “SD2”) was obtained after the above described step (manufacturing the high electrical conductive mayenite compound). The relative density of the black material SD2 was 96.1%.

Further, as a result of X-ray diffraction of the powder obtained by grinding the black material SD2 by the method similar to the example 11, it was revealed that the black material SD2 only included the C12A7 structure. The electron density of the black material SD2 was 1.6×10²¹ cm⁻³ and the electrical conductivity of which was 17 S/cm.

With this, it was confirmed that the black material SD2 was the high electrical conductive mayenite compound.

### Example 13

Similar to the method of the above described example 11, the high electrical conductive mayenite compound was manufactured. However, in this example 13, the sintering temperature was 1340° C. in the above described step (manufacturing the high electrical conductive mayenite compound). Other conditions were similar to those of the example 11.

Here, the partial pressure of oxygen thermodynamically calculated from the equilibrium constant of the oxidation-reduction reaction of aluminum and carbon at 1415° C. was 6.2×10⁻¹⁸ Pa. Thus, it is estimated that the partial pressure of oxygen in the environment in which the compact body SC1 is exposed at 1340° C. was less than 6.2×10⁻¹⁸ Pa by calculation.

With this, a black material whose surface was covered by a yellow powder (hereinafter, referred to as a black material “SD3”) was obtained after the above described step (manufacturing the high electrical conductive mayenite compound). The relative density of the black material SD3 was 95.5%.

Further, as a result of X-ray diffraction of the powder obtained by grinding the black material SD3 by the method similar to the example 11, it was revealed that the black material SD3 only included the C12A7 structure. The electron density of the black material SD3 was 1.5×10²¹ cm⁻³ and the electrical conductivity of which was 16 S/cm.

With this, it was confirmed that the black material SD3 was the high electrical conductive mayenite compound.

Here, the yellow powder that covers the surface of the black material SD3 could be easily removed just by slightly rubbing. The surface after removing the yellow powder was black and it was revealed (confirmed by a tester) that the surface black portion has electrical conductivity.

Further, it was confirmed that the main component of the yellow powder was aluminum carbide Al₄C₃ by X-ray diffraction analysis of the yellow powder.

### Example 14

Similar to the method of the above described example 11, the high electrical conductive mayenite compound was manufactured. However, in this example 14, the sintering temperature was 1300° C. and the holding time was 12 hours in the above described step (manufacturing the high electrical conductive mayenite compound). Other conditions were similar to those of the example 11.

Here, the partial pressure of oxygen thermodynamically calculated from the equilibrium constant of the oxidation-reduction reaction of aluminum and carbon at 1300° C. was 1.6×10⁻²⁰ Pa. Thus, it is estimated that the partial pressure of oxygen in the environment in which the compact body SC1 was exposed was about 1.6×10⁻²⁰ Pa by calculation, in the example 14.

With this, a black material whose surface was covered by a yellow powder (hereinafter, referred to as a black material “SD4”) was obtained after the above described step (manufacturing the high electrical conductive mayenite compound). The relative density of the black material SD4 was 96.2%.

Further, as a result of X-ray diffraction of the powder obtained by grinding the black material SD4 by the method similar to the example 11, it was revealed that the black material SD4 only included the C12A7 structure. The electron density of the black material SD4 was 1.5×10²¹ cm⁻³ and the electrical conductivity of which was 16 S/cm.

With this, it was confirmed that the black material SD4 was the high electrical conductive mayenite compound.

Here, the yellow powder that covers the surface of the black material SD4 could be easily removed just by slightly rubbing. The surface after removing the yellow powder was black and it was revealed (confirmed by a tester) that the surface black portion has electrical conductivity.

Further, it was confirmed that the main component of the yellow powder was aluminum carbide Al₄C₃ by X-ray diffraction analysis of the yellow powder.

### Example 15

Similar to the method of the above described example 11, the high electrical conductive mayenite compound was manufactured. However, in this example 15, the sintering temperature was 1300° C. and the holding time was 2 hours in the above described step (manufacturing the high electrical conductive mayenite compound). Other conditions were similar to those of the example 11.

Here, the partial pressure of oxygen thermodynamically calculated from the equilibrium constant of the oxidation-reduction reaction of aluminum and carbon at 1300° C. was 1.6×10⁻²⁰ Pa. Thus, it is estimated that the partial pressure of oxygen in the environment in which the compact body SC1 was exposed was about 1.6×10⁻²⁰ Pa by calculation, in the example 15.

With this, a black material whose surface was pale yellow (hereinafter, referred to as a black material “SD5”) was obtained after the above described step (manufacturing the high electrical conductive mayenite compound). The relative density of the black material SD5 was 94.1%.

Further, as a result of X-ray diffraction of the powder obtained by grinding the black material SD5 by the method similar to the example 11, it was revealed that the black material SD5 only included the C12A7 structure. The electron density of the black material SD5 was 1.4×10²¹ cm⁻³ and the electrical conductivity of which was 15 S/cm.

With this, it was confirmed that the black material SD5 was the high electrical conductive mayenite compound.

### Example 16

Similar to the method of the above described example 11, the sintered body of the high electrical conductive mayenite compound was manufactured. However, in this example 16, the sintering temperature was 1380° C. and the holding time was 12 hours in the above described step (manufacturing the high electrical conductive mayenite compound). Other conditions were similar to those of the example 11.

Here, the partial pressure of oxygen thermodynamically calculated from the equilibrium constant of the oxidation-reduction reaction of aluminum and carbon at 1415° C. was 6.2×10⁻¹⁸ Pa. Thus, it is estimated that the partial pressure of oxygen in the environment in which the compact body SC1 was exposed was about 6.2×10⁻¹⁸ Pa by calculation, in the example 16.

With this, a black material whose surface was slightly white (hereinafter, referred to as a black material “SD6”) was obtained after the above described step (manufacturing the high electrical conductive mayenite compound). The black material (hereinafter, referred to as a black material “SD6”) was obtained. Here, the shape of the black material SD6 was largely deformed.

Further, as a result of X-ray diffraction of the powder obtained by grinding the black material SD6 by the method similar to the example 11, it was revealed that the black material SD6 only included the C12A7 structure. The electron density of the black material SD6 was 1.0×10²¹ cm⁻³ and the electrical conductivity of which was 13 S/cm.

With this, it was confirmed that the black material SD6 was the high electrical conductive mayenite compound.

### Example 17

Similar to the method of the above described example 11, the high electrical conductive mayenite compound was manufactured. However, in this example 17, an aluminum layer that was used in the same condition as the example 11 was used as the aluminum layer 320 in the above described step (manufacturing the high electrical conductive mayenite compound). It means that the aluminum layer 320 was in a blocklike form in this example 17 as the metal aluminum powder composing the aluminum layer 320 was melted and solidified by the previous heat treatment. Other conditions were similar to those of the example 11.

Here, the partial pressure of oxygen thermodynamically calculated from the equilibrium constant of the oxidation-reduction reaction of aluminum and carbon at 1300° C. was 1.6×10⁻²⁰ Pa. Thus, it is estimated that the partial pressure of oxygen in the environment in which the compact body SC1 was exposed at 1250° C. was less than 1.6×10⁻²⁰ Pa.

With this, a black material whose surface was slightly white (hereinafter, referred to as a black material “SD7”) was obtained after the above described step (manufacturing the high electrical conductive mayenite compound). The relative density of the black material SD7 was 97.2%.

Further, as a result of X-ray diffraction of the powder obtained by grinding the black material SD7 by the method similar to the example 11, it was revealed that the black material SD7 only included the C12A7 structure. The electron density of the black material SD7 was 1.6×10²¹ cm⁻³ and the electrical conductivity was 17 S/cm.

With this, it was confirmed that the black material SD7 was the high electrical conductive mayenite compound.

Further, from this result, it was revealed that the aluminum layer 320 can be recycled. Further, it was confirmed in a subsequent experiment that almost the same high electrical conductive mayenite compound could be obtained even when the aluminum layer 320 was recycled for 10 times in the apparatus 300.

### Example 18

Similar to the method of the above described example 11, the high electrical conductive mayenite compound was manufactured. However, in this example 18, the electrical conductive mayenite compound powder whose electron density was 5.0×10¹⁹ cm⁻³ was used, instead of the mayenite compound, as the powder used in the above described step (manufacturing the compact body of the mayenite compound). Other conditions were similar to those of the example 11.

Here, the partial pressure of oxygen thermodynamically calculated from the equilibrium constant of the oxidation-reduction reaction of aluminum and carbon at 1300° C. was 1.6×10⁻²⁰ Pa. Thus, it is estimated that the partial pressure of oxygen in the environment in which the compact body SC1 was exposed at 1250° C. was less than 1.6×10⁻²⁰ Pa by calculation.

With this, a black material whose surface was slightly white (hereinafter, referred to as a black material “SD8”) was obtained after the above described step (manufacturing the high electrical conductive mayenite compound). The relative density of the black material SD8 was 96.8%.

Further, as a result of X-ray diffraction of the powder obtained by grinding the black material SD8 by the method similar to the example 11, it was revealed that the black material SD8 only included the C12A7 structure. The electron density of the black material SD8 was 1.6×10²¹ cm⁻³ and the electrical conductivity of which was 17 S/cm.

With this, it was confirmed that the black material SD8 was the high electrical conductive mayenite compound.

### Example 19

Similar to the method of the above described example 11, the high electrical conductive mayenite compound was manufactured. However, in this example 19, only the alumina container 310 with the cover 315 and the first carbon container 330 with the cover 335 were used and the second carbon container 350 with the cover 355 was not in the used apparatus 300, in the above described step (manufacturing of the high electrical conductive mayenite compound). Other conditions were similar to those of the example 11.

Here, the partial pressure of oxygen thermodynamically calculated from the equilibrium constant of the oxidation-reduction reaction of aluminum and carbon at 1300° C. was 1.6×10⁻²⁰ Pa.

Thus, it is estimated that the partial pressure of oxygen in the environment in which the compact body SC1 was exposed at 1250° C. was less than 1.6×10⁻²⁰ Pa.

With this, a black material whose surface was slightly white (hereinafter, referred to as a black material “SD9”) was obtained after the above described step (manufacturing the high electrical conductive mayenite compound). The relative density of the black material SD9 was 96.8%.

Further, as a result of X-ray diffraction of the powder obtained by grinding the black material SD9 by the method similar to the example 11, it was revealed that the black material SD9 only included the C12A7 structure. The electron density of the black material SD9 was 1.4×10²¹ cm⁻³ and the electrical conductivity of which was 15 S/cm.

With this, it was confirmed that the black material SD9 is a high electrical conductive mayenite compound.

### Example 20

Similar to the method of the above described example 11, the high electrical conductive mayenite compound was manufactured. However, in this example 20, the pressure in the electric furnace was 30 Pa in the above described step (manufacturing the high electrical conductive mayenite compound). Other conditions were the same as those of the example 11.

Here, the partial pressure of oxygen thermodynamically calculated from the equilibrium constant of the oxidation-reduction reaction of aluminum and carbon at 1300° C. was 1.6×10⁻²⁰ Pa. Thus, it is estimated that the partial pressure of oxygen in the environment in which the compact body SC1 was exposed at 1250° C. was less than 1.6×10⁻²⁰ Pa.

With this, a black material whose surface was slightly white (hereinafter, referred to as a black material “SD10”) was obtained after the above described step (manufacturing the high electrical conductive mayenite compound). The relative density of the black material SD10 was 96.6%.

Further, as a result of X-ray diffraction of the powder obtained by grinding the black material SD10 by the method similar to the example 11, it was revealed that the black material SD10 only included the C12A7 structure. The electron density of the black material SD10 was 1.4×10²¹ cm⁻³ and the electrical conductivity of which was 15 S/cm.

With this, it was confirmed that the black material SD10 was the high electrical conductive mayenite compound.

### Relative Example 6

Similar to the method of the above described example 11, manufacturing the high electrical conductive mayenite compound was attempted. However, in this relative example 6, the sintering temperature was 1200° C. in the above described step (manufacturing the high electrical conductive mayenite compound). Other conditions were similar to those of the example 11.

Here, the partial pressure of oxygen thermodynamically calculated from the equilibrium constant of the oxidation-reduction reaction of aluminum and carbon at 1230° C. was 2.8×10⁻²² Pa. Thus, it is estimated that the partial pressure of oxygen in the environment in which the compact body SC1 was exposed at 1200° C. was less than 2.8×10⁻²² Pa by calculation.

With this, a black material whose surface was slightly white (hereinafter, referred to as a black material “SD11”) was obtained after the above described step (manufacturing the high electrical conductive mayenite compound). The relative density of the black material SD11 was 94.0%.

Further, as a result of X-ray diffraction of the powder obtained by grinding the black material SD11 by the method similar to the example 11, it was revealed that hetero-facies existed in addition to the C12A7 structure in the black material SD11. As the black material SD11 included hetero-facies, accurate electron density and electrical conductivity cannot be obtained, however, the electron density of the black material SD11 was about 3.0×10¹⁹ cm⁻³ and the electrical conductivity of which was 0.2 S/cm.

With this, it was confirmed that the black material SD11 does not have a high electron density.

### Relative Example 7

By a method similar to the above described example 11, manufacturing the high electrical conductive mayenite compound was attempted. However, in this relative example 7, the sintering temperature was 1420° C. in the above described step (manufacturing the high electrical conductive mayenite compound). Other conditions were similar to those of the example 11.

Here, the partial pressure of oxygen thermodynamically calculated from the equilibrium constant of the oxidation-reduction reaction of aluminum and carbon at 1415° C. was 6.2×10⁻¹⁸ Pa. Thus, it is estimated that the partial pressure of oxygen in the environment in which the compact body SC1 was exposed at 1420° C. exceeded 6.2×10⁻¹⁸ Pa by calculation.

With this, a black material whose surface was slightly white (hereinafter, referred to as a black material “SD12”) was obtained after the above described step (manufacturing the high electrical conductive mayenite compound). The black material SD12 was largely deformed. Further, the black material SD12 was adhered to the alumina plate 328 and was not able to be separated from the alumina plate 328. Thus, the alumina plate 328 was broken and only fragments of the black material were collected. The relative density of the black material SD12 was 93.9%.

In order to obtain a measurement sample for electron density, the black material SD12 was milled with rough milling by an alumina automatic mortar mill. First, the black material SD12 was grinded by the alumina mortar mill to carefully remove the slightly white portion at the surface and the rough milling was performed only using the black portion.

The obtained powder was deep green. As a result of X-ray diffraction analysis, it was revealed that hetero-facies existed, not only the C12A7 structure, in the powder. Here, as there existed hetero-facies, accurate electron density and electrical conductivity was not able to be obtained; however, it was estimated that the electron density of the black material SD12 was about 5.2×10¹⁹ cm⁻³ and the electrical conductivity was 0.4 S/cm.

With this, it was confirmed that the black material SD12 does not have a high electron density.

### Relative Example 8

By a method similar to the above described example 11, manufacturing the high electrical conductive mayenite compound was attempted. However, in this relative example 8, only the alumina container 310 with the cover 315 was used and the first carbon container 330 with the cover 335 and the second carbon container 350 with the cover 355 were not used in the used apparatus 300 in the above described step (manufacturing of the high electrical conductive mayenite compound). Other conditions were similar to those of the example 11.

Here, the partial pressure of oxygen thermodynamically calculated from the equilibrium constant of the oxidation-reduction reaction of aluminum at 1300° C. was 6.4×10⁻²² Pa. Thus, it is estimated that the partial pressure of oxygen in the environment in which the compact body SC1 was exposed at 1250° C. was less than 6.4×10⁻²² Pa.

With this, a black material whose surface was slightly white (hereinafter, referred to as a black material “SD13”) was obtained after the above described step (manufacturing the high electrical conductive mayenite compound). The relative density of the black material SD13 was 93.0%.

Further, as a result of X-ray diffraction of the powder obtained by grinding the black material SD13 by the method similar to the example 11, it was revealed that the black material SD13 only included the C12A7 structure. Further, the electron density obtained from the light diffusion reflection spectrum of the obtained powder by Kubelka-Munk transformation was 1.2×10¹⁹ cm⁻³ and whose electrical conductivity of which was 0.1 S/cm.

With this, it was confirmed that the black material SD13 does not have a high electron density.

### Relative Example 9

By a method similar to the above described example 11, manufacturing the high electrical conductive mayenite compound was attempted. However, in this relative example 9, the alumina block 325 and the alumina plate 328 were not used and the compact body of the mayenite compound was directly provided on the aluminum layer 320 in the used apparatus 300 in the above described step (manufacturing of the high electrical conductive mayenite compound). Other conditions were similar to those of the example 11.

Here, the partial pressure of oxygen thermodynamically calculated from the equilibrium constant of the oxidation-reduction reaction of aluminum and carbon at 1300° C. was 1.6×10⁻²⁰ Pa. Thus, it is estimated that the partial pressure of oxygen in the environment in which the compact body SC1 was exposed at 1250° C. was less than 1.6×10⁻²⁰ Pa.

With this, a black material (hereinafter, referred to as a black material “SD14”) was obtained after the above described step (manufacturing the high electrical conductive mayenite compound). Half of the black material SD14 was sunk in the aluminum layer 320 and was not able to be easily collected.

Thus, the black material SD14 was collected with the aluminum layer 320 by breaking the alumina container 310 by a hammer. To the surface of the black material SD14, a silvery-white fused material of metal aluminum was adhered and a white material, which was considered as alumina, was further strongly adhered. These materials were carefully removed by using a power saw, a ceramics Leutor (grinder) and sandpaper, and then, the relative density and the electron density of the black material SD14 were examined. The relative density of the black material SD14 was 91.4%.

Further, as a result of X-ray diffraction of the powder obtained by grinding the black material SD14 by the method similar to the example 11, it was revealed that the black material SD14 only included the C12A7 structure. The electron density of the black material SD14 was 1.4×10²¹ cm⁻³ and the electrical conductivity of which was 15 S/cm. With this, it was confirmed that the black material SD14 was the high electrical conductive mayenite compound.

However, by the relative example 9, it was revealed that a large effort was necessary to collect the electrical conductive mayenite compound. Thus, it is considered that this method does not suit industrial production.

### Relative Example 10

By a method similar to the above described example 11, manufacturing the high electrical conductive mayenite compound was attempted. However, in this relative example 10, the alumina container 310 with the cover 315 and the aluminum layer 320 were not used in the used apparatus 300, in the above described step (manufacturing of the high electrical conductive mayenite compound). It means that in this relative example 10, only the first carbon container 330 with the cover 335 and the second carbon container 350 with the cover 355 were used, and the sintering process of the compact body SC1 was performed under an environment without aluminum vapor.

Further, during the sintering process, first, the furnace was evacuated to be 100 Pa, and then, nitrogen gas, in which the oxygen concentration was less than or equal to 1 volume ppm, was introduced to the furnace to became atmospheric pressure. Thereafter, the second carbon container 350 was heated to 1600° C. within 4 hours, held at the temperature for 2 hours, and then cooled to be room temperature within 4 hours.

Thus, the partial pressure of oxygen in the environment in which the compact body SC1 was exposed was about 0.1 Pa, in this relative example 10.

With this, a black material whose surface was black (hereinafter, referred to as a black material “SD15”) was obtained.

The black material SD15 was fused to the first carbon container 330 and was not able to be easily collected. Thus, the first carbon container 330 was broken by a hammer and only scattered fragments of the black material SD15 were collected.

Further, as a result of X-ray diffraction of the powder obtained by grinding the black material SD15 by the method similar to the example 11, it was revealed that the black material SD15 only included the C12A7 structure. However, the electron density of the black material SD15 was 3.4×10¹⁹ cm⁻³.

With this, it was confirmed that the black material SD15 does not have a high electron density.

### Relative Example 11

By a method similar to the above described relative example 10, manufacturing the high electrical conductive mayenite compound was attempted. However, in this relative example 11, a black material SD16 was obtained by heating to 1300° C. within 4 hours, holding at the temperature for 6 hours, and then cooling to be room temperature within 4 hours. The black material SD16 was not adhered to the carbon container and could be easily collected.

Further, as a result of X-ray diffraction of the powder obtained by grinding the black material SD16 by the method similar to the example 11, it was revealed that the black material SD16 only included the C12A7 structure. However, the electron density of the black material SD16 was 4.8×10¹⁹ cm⁻³.

With this, it was confirmed that the black material SD16 does not have a high electron density.

The sintering temperature, time, and whether aluminum vapor was used for the compact body, and the crystalline structure, the relative density, the electron density, and the electrical conductivity of the obtained black material, of the examples 11 to 20 and the relative examples 6 to 11 are illustrated in Table 2.

TABLE 2

| | SINTERING | | | | | RELATIVE | ELECTRON | ELECTRICAL |
|---|---|---|---|---|---|---|---|---|
| | TEMPERATURE | TIME | | | CRYSTALLINE | DENSITY | DENSITY | CONDUCTIVITY |
| EXAMPLE | (° C.) | (H) | Al VAPOR | OTHERS | STRUCTURE | (%) | (cm⁻³) | (S/cm) |
| EXAMPLE 11 | 1250 | 6 | WITH | | C12A7 | 97.0 | 1.6 × 10²¹ | 17 |
| EXAMPLE 12 | 1300 | 6 | WITH | | C12A7 | 96.1 | 1.6 × 10²¹ | 17 |
| EXAMPLE 13 | 1340 | 6 | WITH | | C12A7 | 95.5 | 1.5 × 10²¹ | 16 |
| EXAMPLE 14 | 1300 | 12 | WITH | | C12A7 | 96.2 | 1.5 × 10²¹ | 16 |
| EXAMPLE 15 | 1300 | 2 | WITH | | C12A7 | 94.1 | 1.4 × 10²¹ | 15 |
| EXAMPLE 16 | 1380 | 12 | WITH | | C12A7 | — | 1.0 × 10²¹ | 13 |
| EXAMPLE 17 | 1250 | 6 | WITH | ALUMINIUM | C12A7 | 97.2 | 1.6 × 10²¹ | 17 |
| | | | | LAYER IS | | | | |
| | | | | RECYCLED | | | | |
| EXAMPLE | 1250 | 6 | WITH | ELECTRICAL | C12A7 | 96.8 | 1.6 × 10²¹ | 17 |
| 18 | | | | CONDUCTIVE | | | | |
| | | | | MAYENITE | | | | |
| | | | | COMPOUND | | | | |
| | | | | POWDER | | | | |
| | | | | WAS USED | | | | |
| EXAMPLE | 1250 | 6 | WITH | SECOND | C12A7 | 96.8 | 1.6 × 10²¹ | 17 |
| 19 | | | | CARBON | | | | |
| | | | | CONTAINER | | | | |
| | | | | WAS NOT | | | | |
| | | | | USED | | | | |
| EXAMPLE 20 | 1250 | 6 | WITH | PRESSURE | C12A7 | 96.6 | 1.4 × 10²¹ | 15 |
| | | | | WAS 30Pa | | | | |
| RELATIVE | 1200 | 6 | WITH | | C12A7 + | 94.0 | 3.0 × 10¹⁹ | 0.2 |
| EXAMPLE 6 | | | | | HETEROFACIES | | | |
| RELATIVE | 1420 | 6 | WITH | | C12A7 + | 93.9 | 5.2 × 10¹⁹ | 0.4 |
| EXAMPLE 7 | | | | | HETEROFACIES | | | |
| RELATIVE | 1250 | 6 | WITH | FIRST AND | C12A7 | 93.0 | 1.2 × 10¹⁹ | 0.1 |
| EXAMPLE 8 | | | | SECOND | | | | |
| | | | | CARBON | | | | |
| | | | | CONTAINERS | | | | |
| | | | | WERE NOT | | | | |
| | | | | USED | | | | |
| RELATIVE | 1250 | 6 | WITH (BODY | | C12A7 | 91.4 | 1.4 × 10²¹ | 15 |
| EXAMPLE 9 | | | DIRECTLY | | | | | |
| | | | CONTACT | | | | | |
| | | | SOURCE) | | | | | |
| RELATIVE | 1600 | 2 | WITHOUT | N₂ | C12A7 | — | 3.4 × 10¹⁹ | — |
| EXAMPLE 10 | | | | ATMOSPHERE | | | | |
| RELATIVE | 1600 | 2 | WITHOUT | N₂ | C12A7 | — | 4.8 × 10¹⁹ | — |
| EXAMPLE 11 | | | | ATMOSPHERE | | | | |

What is claimed is:

1. A method of manufacturing an electrical conductive mayenite compound, comprising:
(1) a step of preparing a calcinated powder including calcium oxide and aluminum oxide at a ratio of 13:6 to 11:8 (based on molar ratio as converted to CaO:Al₂O₃); and
(2) a step of placing a body to be processed including the calcinated powder prepared in the step (1) in the presence of carbon monoxide gas and aluminum vapor supplied from an aluminum source without contacting the aluminum source, and holding the body to be processed at a temperature range of 1220° C. to 1350° C. under reducing atmosphere.

2. The method of manufacturing the electrical conductive mayenite compound according to claim 1,
wherein the calcinated powder is manufactured by performing a heat treatment on a mixture of
a raw material A including at least one selected from a group consisting of calcium oxide, calcium carbonate and calcium hydroxide, and
a raw material B including at least one selected from a group consisting of aluminum oxide and aluminum hydroxide.

3. The method of manufacturing the electrical conductive mayenite compound according to claim 2, wherein the heat treatment is performed at 500° C. to 1200° C.

4. The method of manufacturing the electrical conductive mayenite compound according to claim 1, wherein the body to be processed including the calcinated powder is a compact body including the calcinated powder.

5. The method of manufacturing the electrical conductive mayenite compound according to claim 1, wherein the step (2) is performed at a state where the body to be processed and the aluminum source are put in a container containing carbon.

6. The method of manufacturing the electrical conductive mayenite compound according to claim 1, wherein the step (2) is performed under a reduced pressure environment less than or equal to 100 Pa, or under inert-gas, except nitrogen, atmosphere.

7. The method of manufacturing the electrical conductive mayenite compound according to claim 1, wherein in the step (1), the calcinated powder including calcium oxide and aluminum oxide at a ratio of 12.6:6.4 to 11.7:7.3 (based on molar ratio as converted to CaO:Al₂O₃) is prepared.

8. A method of manufacturing an electrical conductive mayenite compound, comprising:
(1) a step of preparing a mayenite compound powder; and
(2) a step of placing a body to be processed including the compound powder prepared in the step (1) in the presence of carbon monoxide gas and aluminum vapor supplied from an aluminum source without contacting the aluminum source, and holding the body to be processed at a temperature range of 1230° C. to 1415° C. under reducing atmosphere.

9. The method of manufacturing the electrical conductive mayenite compound according to claim 8, wherein the step (2) is performed under a state where the body to be processed and the aluminum source are put in a container containing carbon.

10. The method of manufacturing the electrical conductive mayenite compound according to claim 8, wherein the electrical conductive mayenite compound having an aluminum carbide layer at a surface is obtained by the step (2).

11. The method of manufacturing the electrical conductive mayenite compound according to claim 8, wherein the body to be processed including the mayenite compound powder is a compact body including the mayenite compound powder.

12. The method of manufacturing the electrical conductive mayenite compound according to claim 8, wherein the step (2) is performed under a reduced pressure environment less than or equal to 100 Pa, or under inert-gas, except nitrogen, atmosphere.

13. The method of manufacturing the electrical conductive mayenite compound according to claim 8, wherein the electrical conductive mayenite compound whose electron density is more than or equal to 3×10²⁰ cm⁻³ is obtained.
